(19) United States
(12) Patent Application Publication
(10) Pub. No.: US 2013/0061261 A1
(43) Pub. Date: Mar. 7, 2013

(54) WIRELESS PROMOTIONAL AND INFORMATION OFFER DELIVERY SYSTEM FOR USE WITH INTERACTING WITH BROADCAST, CABLE, BROADBAND AND OUT-OF-HOME MEDIA, RADIO PLATFORMS AND MOVIE THEATERS

(71) Applicant: Andrew Pakula, Suffern, NY (US)

(72) Inventor: Andrew Pakula, Suffern, NY (US)

(21) Appl. No.: 13/291,493

(22) Filed: Nov. 8, 2011

Related U.S. Application Data
(60) Provisional application No. 61/412,549, filed on Nov. 11, 2010.

(51) Int. Cl. H04N 21/23

(52) U.S. Cl. 725/32

(57) ABSTRACT

A method for a wireless promotional offer delivery (WPOD) system to deliver promotional offers broadcast in radio and television advertising or programming content to mobile devices or fixed computer stations is presented. A WPOD application, downloaded onto a mobile device or fixed computer station, allows for the capture of timed segments of the content. The content, sent by the WPOD application to a WPOD server, is analyzed and matched to a unique digital ID. The digital ID is returned to the mobile device or fixed computer station. The WPOD application then delivers the digital ID to the server along with the user's current geographical position coordinates, client ID and date/time stamp. The WPOD server looks up the digital ID and matches any “live” offers then available, and delivers such offer back to the WPOD application. The user of the WPOD application may then act upon the promotional offer.

### PRIOR PROVISIONAL APPLICATION

The present application claims the benefit of U.S. Provisional Application Ser. No. 61/412,549 filed Nov. 11, 2010, the disclosure of which is hereby incorporated by reference.

### FIELD OF THE INVENTION

The present invention relates to a method and apparatus for the wireless delivery of promotional offers to mobile devices, including phones, tablets and computers, by interacting with television, radio and other media content, and, more particularly, to a method and apparatus for the integration and operation of various management system applications to deliver promotions, offers, information and products sales, including, but not limited to, such things as: coupons, calendar events and reminders, PDF downloaded information, automatic auto dial features, provision of phone numbers, provision of contact information, redirection to web sites, down load of apps, purchase of products, find-nearest-retailer features to buy products and services, requests to be contacted, watching of videos, entering of sweepstakes, voting, and other assorted actions and information, by interacting with broadcast, cable, broadband and out-of-home television and radio platforms, or in movie theaters or from kiosks and any other audio, video or print source.

### BACKGROUND OF THE INVENTION

Since the late 1970's when cable television was first introduced on a mass scale to TV viewing households, cable companies have promised, through their installed cable boxes, to advertisers and the like the ability to address and deliver appropriate advertising to a targeted TV household while offering the viewer the ability to interact and engage with programming and advertising.

Because of the complexity, technical design and cost to the cable system in installing software and hardware, and the many different cable system infrastructure and cable boxes, cable companies found it difficult to implement a seamless and robust interactive TV system.

In the mid-1990's, marketers began to look at the emerging Internet as a quicker and more cost efficient solution to provide addressable, interactive advertising and information to Internet consumers, usurping the need to use complex cable interactive TV systems.

By the mid-2000's, as the Internet grew to hundreds of millions users worldwide, and technology became faster and more efficient a new mobile wireless industry began to emerge. Because of its ability to deliver the web wirelessly, anywhere and un-tethered from their online connected computers, more and more users were using mobile devices wirelessly as a mechanism to communicate, shop, be informed, manage their lives, be entertained, and find directions.

As a result, more people now use their mobile devices everywhere and anytime, while they watch TV, go to the movies, and shop. This newly emerging multi-tasking environment is what provides the opportunity for use of the present invention.

With that being said, however, promotional offers or coupons for discounted goods and/or services, and associated information, are only useful to the extent that they can be distributed to the receiving and consuming public. Advertisers always enjoyed TV advertising because it delivers a mass audience with high quality creative content. Television advertising is the highest spending category for all media, outspending the closest Internet media category by about 3 to 1. Thus, to an advertiser, the holy-grail has been to combine their TV advertising with interactivity and thereby allowing the advertisers to directly interact with consumers and provide a level of accountability, efficiency and effectiveness not before seen.

Up until now, any interactivity by/with consumers with television or radio advertisers has been through calling 800's or URL's that have appeared in commercials, essentially directing viewers to write down phone numbers and URL's then type in those numbers by hand in their devices or computers.

With the advent of the print and digital media ages, promotional offers, information distribution and coupon distribution has taken many forms. As technology became more prevalent with its capability to deliver more information quickly via computers, companies have utilized the web and email to deliver promotions offers, information and coupons for goods and services, provided they can be distributed to the consumer with efficiency and accuracy.

Print media distribution included such things as newspapers, magazines, coupon books, and flyers. However, such distribution means is inefficient, highly costly and even an inconvenience to some. With the high cost of postage and printing, the internet has been an efficient digital way to communicate, including delivery of information and even brochures.

With the growth of digital capabilities, marketers are saving money on printed brochures, allowing consumers to receive PDF files saving money on printing. Digital media distribution also includes websites that offer promotions, information and coupons (e.g., which can be printed at home and then used at the retail store). Coupons could also be loaded up on retail store cards, or dispensed from coupon dispensing machines located in the store. With the growth of digital couponing and mobile devices, retail stores are starting to accept digital coupons from wireless devices.

While clipping coupons from newspapers has been the longest and most popular way to obtain coupons, coupons garnered through the internet and/or mobile phone apps are gaining wide popularity. Such is the case because a problem associated with print media coupons is the mass amount of clutter and disorganization. The internet coupons promoted and obtainable from online retailers, on the other hand, typically utilize secret words or codes distributed to the consumer and known as “coupon codes”, “promotional”, “discount codes”, etc. However, such internet coupons are unusable without the code. And coupons distributed via mobile phone applications often require various internet applications such as SMS or MMS or other mobile applications.

The Internet has also been an efficient way for marketers to build retail stores online allowing consumers to purchase items without going to brick and mortar locations, saving on the cost to build and support brick and mortar stores. Today's GPS technology also provides marketers and advertisers the opportunity to communicate to consumers where the local location is to purchase their products or use their service.

However all of these various applications do not provide for one comprehensive management, processing and delivery, and tracking and reporting system. Indeed, as the growth of digital marketing extends to mobile devices, there is not one comprehensive system in place that provides consumers with a convenient and efficient interact application allows them to interact with TV advertising and content, radio advertising and content and other audio media and print media with their mobile devices. By doing so, such would enable consumers to receive promotions, offers and information quickly while providing an all-inclusive, efficient and effective means of communicating for advertisers and marketers through a series of marketing actions which are delivered to the consumers mobile device either globally, nationally, regionally of hyper-locally, along with a robust management, tracking and reporting system that allows marketers to optimize their offers against their TV, radio and other media.

### SUMMARY OF THE INVENTION

Accordingly, the present invention is directed to providing a method and apparatus for a wireless advertising, promotional, information and offer delivery system which would enable domestic and international television and radio advertisers to seamlessly deliver exclusive, highly targeted promotions, offers, information and products sales to wireless mobile devices directly from linear television and radio commercials and programming either globally, nationally, regionally or hyper-locally.

Through a mobile app running on a customer's phone, advertisers, marketers and retailers can offer a wide variety of marketing actions to a TV viewer or radio listener a number of promotions, offers, information including, but not limited to: promotional offers and coupons, reminders, contact information, calendar reminder events, product sales, provide directions to retail and service locations, website addresses, PDF brochures, application downloads and many other merchandisable marketing actions. It is to be understood, of course, that in addition to working with television and radio the WPOD system can also operate: in movie theatres, in other out-of-home environments such as animated bus stop shelters, animated bill boards or television bill boards, and even in stadiums where they have large electronic billboards that can use audio and video, and by computer.

All of the above tasks are delivered automatically and reaching and/or culminating in the customer's file application wirelessly to the customers mobile device for the consumer to interact with through the wireless promotional delivery system by the: uploading administration information and information on clients and their agencies on a WPOD database server to create administration passwords and passwords to access reports; uploading contact information for a client, the clients product, their agencies and geographical locations of where to purchase the clients' products or receive services on the WPOD database server; dynamically generating unique ID's for each client, each of their products and geographical location information on the WPOD database server; associating the client and product information with the advertising and programming content on the WPOD database server; uploading audio and video advertising or programming content on the WPOD database server; analyze the uploaded audio and video advertising or programming content to dynamically create a unique digital ID based on the audio and video track of the advertising and programming content on the WPOD database server; uploading the unique digital ID of the advertising or programming content to the WPOD database server; dynamically generating a unique ID for the associated client/product information and advertising and programming content on the WPOD database server; uploading a promotional offer including information about the offer along with selected marketing actions on the WPOD database server; uploading PDF files, URL's, phone numbers, calendar information for each marketing action on the WPOD database server; dynamically generating a unique ID for the promotional offer and each marketing action on the WPOD database server; uploading a media schedule on the WPOD database server for the offer to coincide with advertising and programming TV schedules; dynamically generating a unique ID for the media schedule for combining the offer and advertising or programming content; associating the unique digital ID for the advertising and programming content with the unique ID for the promotional offer; uploading pricing for the offer schedule on the WPOD database server; dynamically generating a unique ID for the pricing; capturing a audio or video timed segment on the mobile device; sending the captured audio or video timed segment to the WPOD content server; analyzing the captured audio or video segment; matching the captured audio or video timed segment to the unique digital ID; returning the unique digital ID to the WPOD application on the mobile device; delivering the unique digital ID and the mobile devices current longitude and latitude coordinates, consumer ID and date/time stamp to the WiOffer server; looking up the unique digital ID; matching the “live” campaign offer with the digital ID; delivering the most updated promotional offers and associated actions back to the mobile device or fixed computer station; removal of the offer either manually or upon expiration of the offer on the mobile device; and uploading to a companion website so that a registered user can see its offers at the WPOD website on a computer in addition to the mobile application. Additionally, the customer can socialize such offers through the various internet social sites such as face book, twitter and instant messaging systems. Such will allow for a highly convenient and efficient distribution and use system.

The WPOD system comprises various software application components, including: the mobile application for consumer interface, campaign management application, an administrative and password application, a digital content management and identification application, a promotion, offer, information and products sales management application, an offer delivery application, an offer and action creation and content association application, a live campaign management and pricing application, a tracking and reporting application. Much of the above-components allow the system when combined to be a highly efficient, targeted and automated system which allows for optimization of offers, promotions, information and product sales.

The present invention, including its features and advantages, will become more apparent from the following detailed description with reference to the accompanying drawings.

### BRIEF DESCRIPTION OF THE DRAWINGS

FIG. 1 is an illustration of a diagram of the software architecture of the wireless promotional delivery (WPOD) system, according to an embodiment of the present invention.

FIG. 2 is an illustration of a diagram of the architecture of the wireless promotional offer delivery system, according to an embodiment of the present invention.

FIG. 3 is an illustration of a methodology by which the digital rights management and the offer management systems of the wireless promotional offer delivery system operate, according to an embodiment of the present invention.

FIG. 4 is an example of a screen shot of the WPOD Login screen, according to an embodiment of the present invention.

FIG. 5 is an example of a screen shot of an administrative information “company/agency/client” selection screen, according to an embodiment of the present invention.

FIG. 6 is an example of a screen shot of an administrator information entry screen, according to an embodiment of the present invention.

FIG. 7 is an example of a screen shot of an administrator's list, according to an embodiment of the present invention.

FIG. 8 is an example of a screen shot of a client information selection screen, according to an embodiment of the present invention.

FIG. 9 is an example of a screen shot of a client information entry screen, according to an embodiment of the present invention.

FIG. 10 is an example of a screen shot of a client list, according to an embodiment of the present invention.

FIG. 11 is an example of a screen shot of a product information entry screen, according to an embodiment of the present invention.

FIG. 12 is an example of a screen shot of a products list, according to an embodiment of the present invention.

FIG. 13 is an example of a screen shot of a client geography information entry screen, according to an embodiment of the present invention.

FIG. 14 is an example of a screen shot of a content information selection screen, according to an embodiment of the present invention.

FIG. 15 is an example of a screen shot of a client content and information entry screen, according to an embodiment of the present invention.

FIG. 16 is an example of a screen shot of a product content and content upload information entry screen, according to an embodiment of the present invention.

FIG. 17 is an example of a screen shot of a product content list, according to an embodiment of the present invention.

FIG. 18 is an example of a screen shot of an offer's information selection screen, according to an embodiment of the present invention.

FIG. 19 is an example of a screen shot of an offer's information addition screen, according to an embodiment of the present invention.

FIG. 20 is an example of a screen shot of an offer's content offer input description and information input screen, according to an embodiment of the present invention.

FIG. 21 is an example of a screen shot of a new product offer information entry and action input edit screen, according to an embodiment of the present invention.

FIG. 22 is an example of a screen shot of a new product offer information and action input entry screen, according to an embodiment of the present invention.

FIG. 23 is an example of a screen shot of a new product offer information and action input entry screen, according to an embodiment of the present invention.

FIG. 24 is an example of a screen shot of a live offers selection screen, according to an embodiment of the present invention.

FIG. 25 is an example of a screen shot of an offer schedule content information entry screen, according to an embodiment of the present invention.

FIG. 26 is an example of a screen shot of an offer schedule content information entry screen, according to an embodiment of the present invention.

FIG. 27 is an example of a screen shot of an offer schedule content information entry screen, according to an embodiment of the present invention.

FIG. 28 is an example of a screen shot of a schedule content information entry-completed screen, according to an embodiment of the present invention.

FIG. 29 is an example of a screen shot of a live offers list screen, according to an embodiment of the present invention.

FIG. 30 is an example of a screen shot of a reports selection screen, according to an embodiment of the present invention.

FIG. 31 is an example of a screen shot of a daily report screen, according to an embodiment of the present invention.

FIG. 32 is an example of a screen shot of a daily click report screen, according to an embodiment of the present invention.

FIG. 33 is an illustration of a methodology by which a mobile application for a consumer interface for the wireless promotional offer delivery system operates, according to an embodiment of the present invention.

FIG. 34 is an example of a screen shot of a customer search and edit functionality selection screen, according to an embodiment of the present invention.

FIG. 35 is an illustration of portable handheld wireless devices showing functionality screen shots on which the WPOD device application is located upon download and where the registration component takes place, according to an embodiment of the present invention.

FIG. 36 is an illustration of how portable handheld wireless devices settings take place, according to an embodiment of the present invention.

FIG. 37 is an illustration of a methodology by which a lookup and delivery capability for processing of content and offers is accomplished according to the wireless promotional offer delivery system, according to an embodiment of the present invention.

FIG. 38 is an illustration of the use of a portable handheld wireless device with the WPOD application opened and ready to ingest audio signals, according to an embodiment of the present invention.

FIG. 39 is an illustration of the delivery of the file and/or content created by the listening and capture feature of the portable handheld wireless device to the WPOD server, according to an embodiment of the present invention.

FIG. 40 is an illustration of the communication between the WPOD Content Server and the WiOffer application resident on the mobile device for the delivery of the content Unique Delivery Digital ID, according to an embodiment of the present invention.

FIG. 41 is an illustration of the Unique Digital ID, User ID, Longitude & Latitude information being passed from the WiOffer application on the portable handheld wireless device to the WPOD database server, according to an embodiment of the present invention.

FIG. 42 is an illustration of a methodology by which the user may receive, act on or socialize the offers received by the wireless promotional offer delivery system, according to an embodiment of the present invention.

FIG. 43 is an illustration of a methodology for the lookup of the current offers and the delivery of such offers back to the WPOD device, according to an embodiment of the present invention.

FIG. 44 is an illustration of a portable handheld wireless device showing the listed offers by most recent date until expiration and the folder in which such listed offers are stored, according to an embodiment of the present invention.

FIG. 45 is an illustration of a portable handheld wireless device having the WPOD device application and the various action applications which can be utilized through the wireless device, according to an embodiment of the present invention.

FIG. 46 is an illustration of a portable handheld wireless device showing the device the various interactive response functionality of the WPOD device application for a particular product offer, according to an embodiment of the present invention.

FIG. 47 is an illustration of a portable handheld wireless device showing the various interactive response functionality of the WPOD device application for a particular product offer, according to an embodiment of the present invention.

FIG. 48 is an illustration of a portable handheld wireless device showing interactive response functionality of the WPOD device application for a specific product, according to an embodiment of the present invention.

FIG. 49 is an illustration of a portable handheld wireless device showing the socialization, functionality of the WPOD device application, according to an embodiment of the present invention.

FIG. 50 is an illustration of a methodology by which tracking and reporting to the client is accomplished by the wireless promotional offer delivery system, according to an embodiment of the present invention.

FIG. 51 is an example of a screen shot of a report login screen for the WPOD management system, according to an embodiment of the present invention.

FIG. 52 is an example of a screen shot of an external a daily report screen, according to an embodiment of the present invention.

FIG. 53 is an example of a screen shot of an external daily click report obtainable through the WPOD management system, according to an embodiment of the present invention.

FIG. 54 is an illustration of a methodology by which the user accomplishes viewing of the promotional offers and/or coupons and downloads same on-line at the WPOD website, according to an embodiment of the present invention.

FIG. 55 is an example of a screen shot of a WPOD sign in or download app screen, according to an embodiment of the present invention.

FIG. 56 is an example of a screen shot of the various exemplary retailers through which the user may gain access to such retailer offers through the WPOD website, according to an embodiment of the present invention.

### DETAILED DESCRIPTION

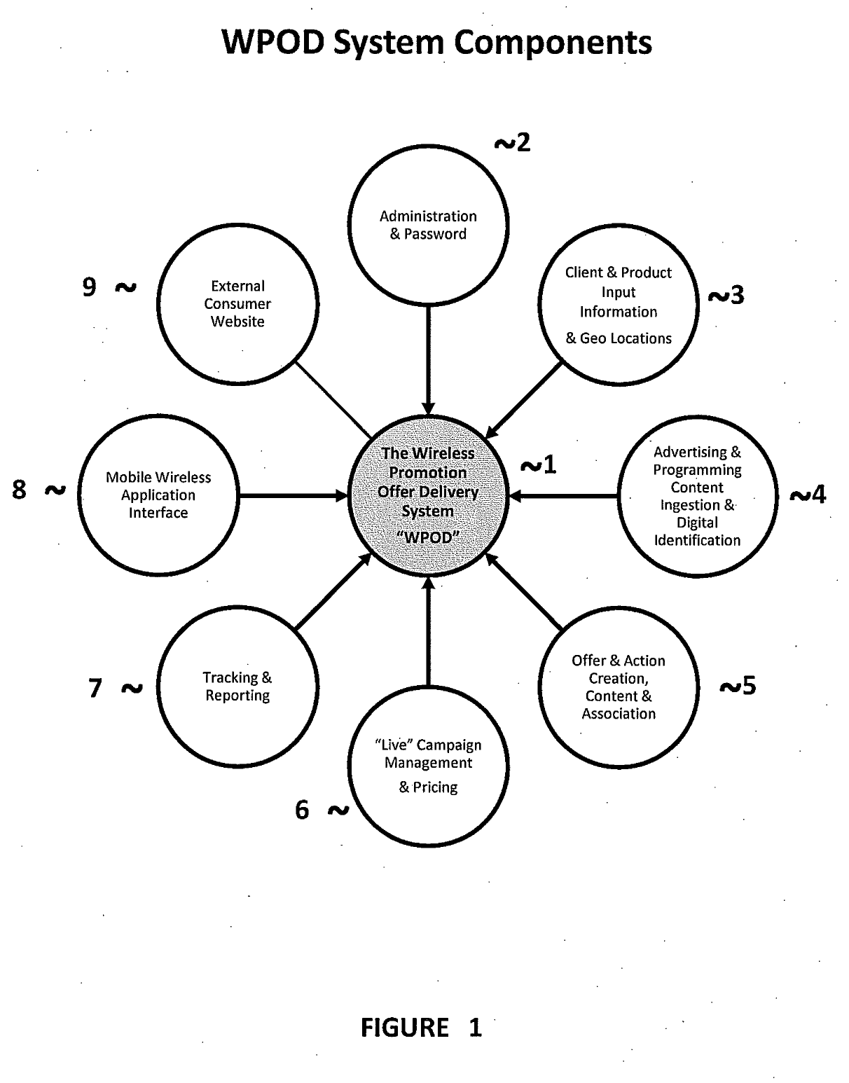

FIGS. 1 through 56 illustrate a method and apparatus for a Wireless Promotional Offer Delivery (WPOD) system for use with broadcast, cable, broadband and out-of-home television and radio platforms and/or communication media.

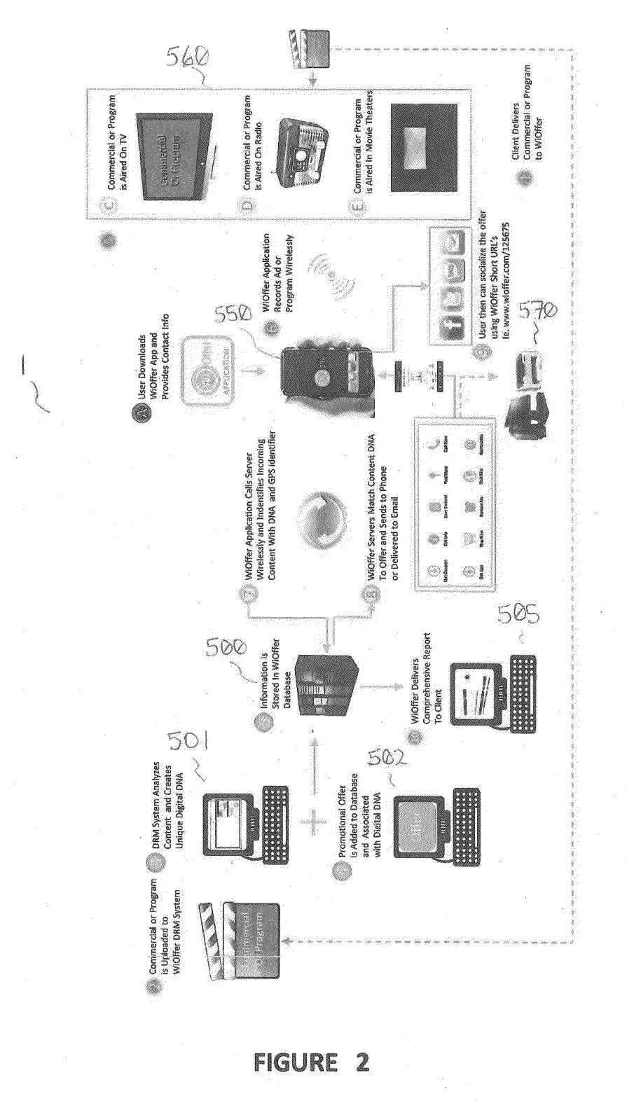

Referring to FIGS. 1 and 2, the overall software architecture and apparatus of the WPOD system is shown. As can be seen, the WPOD system utilizes various software applications that allow for control and integration of various system components in handheld mobile devices, fixed computer stations and databases, and various forms of communication media.

Referring now specifically to FIG. 1, the WPOD system 1 has eight main software application components. These are: the administration & password application 2; the client & product input information and geographical location applications 3; the advertising & programming content ingestion & digital ID application 4; the offer & action creation, content & association applications 5; the “live” campaign management & pricing application 6; the tracking and reporting applications 7; the mobile wireless application interface 8; and the external consumers website 9.

The administrative and password application 2 allow for administrative and security control. The client & product content management application 3 provides for client and product input information and the further input of geographical locations into the WPOD database 500. The advertising & programming content ingestion management application 4 provides for the uploading and storage of client content (e.g., commercials, programs, etc.) and “identification” of such content. Such coding is the assignment of unique ID's to the client, content and promotions, offers, information or product sales to be associated with the content. The assignment of offers and actions to the content management application 5 is the WPOD system component that allows for the assignment of the unique IDs to the promotions, offers, information and product sales offers, and the association of such promotions, offers, information and product sales to the unique ID of the client content. The processing applications 6 allow for the look-up (i.e., analysis), retrieval and delivery of the associated promotions, offers, information and products sales with the aired client content. The tracking and reporting applications 7 of the WPOD system allow for the tracking and reporting of the activity of the promotions, offers, and information and product sales by the consumer. The WPOD system mobile application 8, “i.e., consumer interface”, is the software application for the consumer's mobile wireless device (e.g., mobile phone, tablet, ipad, etc.). The external consumer website 9 allow for consumer access and management through the website. Each will be described in further detail below.

Referring now specifically to FIG. 2, the physical apparatus and interactive structure of the WPOD system 1 is shown. The WPOD System 1 comprises a WiOffer WPOD server database 500, at least one data entry port 501, 502, and 505, a handheld wireless smart phone or tablet 550 (or other mobile device) capable of having the WiOffer WPOD application downloaded into its memory, television or other display device 550 and a home computer system 570. Additionally shown are the overall functional features of the WPOD System 1. For instance, the digital rights management and identification (DRM) system allows for analysis of the offer content and creation of a unique digital ID by an administrator at terminal 501. Additionally promotions, offers, information and products sales may be added to the database and associated with the digital ID at terminal 502. This information is stored in the WiOffer WPOD server database 500. Comprehensive reports may be offered and delivered to the client at terminal 505. The WPOD system user may download the WPOD System application on the handheld wireless device 550. Utilizing the handheld smart phone or tablet 550, the mobile device can see the video or listen to the audio that has aired as a commercial or program through the digital display 560 where a sample is recorded and captured. The captured audio sample is then delivered wirelessly to the WiOffer WPOD server 500 where it is analyzed and matched. Once the audio has been identified and matched, the promotions, offers, information and or product sale is delivered to the WPOD application on the consumers' wireless device. Simultaneously, the identical promotions, offers, information and or product sales are available on a password protected website for consumer access where the information may be viewed or printed out at the home computer 570.

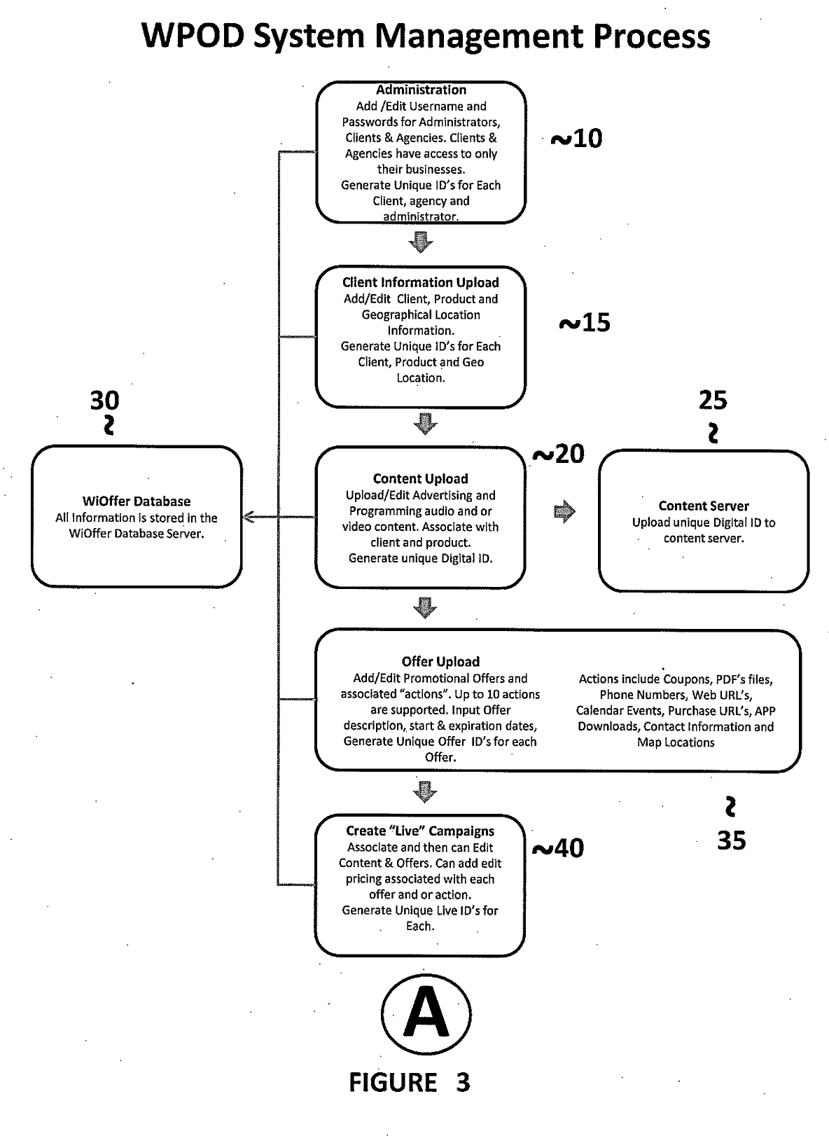

Referring now specifically to FIG. 3, the methodology of the digital content management and offer management components of the WPOD system is shown. In step 10, the usernames and passwords for the WPOD system administrators, clients and agencies are added and/or edited. It is to be noted, that clients and agencies will have access to only their businesses. Upon entry of such information, Unique ID's are generated for each client, agency and/or administrator.

In step 15, the client, product and geographical location information is added and/or edited. As before, upon entry, Unique ID's for each client, product and geographical location are generated.

In step 20, audio and/or video content from a client (e.g., commercials, programs, etc.,) is uploaded. The content is then associated with a client and product, and a unique Digital ID is generated for the client for whom the offer will be associated with. The unique Digital ID will be associated with the client information, the contact information of that client, the product of the client and any geographical locations associated with the client.

In step 25 the content and unique Digital ID's are uploaded to the WPOD content server. And in step 30, all data information is stored to the WPOD-system database.

In step 35, the promotions, offers, information and product sale information and associated “actions” are added and/or edited. In each instance, the promotion, offer, information and product sale description, start and expiration dates can be uniquely inputted.

The promotions, offers, information and products sale information are those that the client wants to associate with the commercials or programs (i.e., content), and can include such things as: coupons, PDF information, sweepstakes, voting options, GPS store location of the nearest client's retailer or office, product discounts, links to a webpage for retail or informational purposes, dates and/or times for a calendar event including a sale, a tune-in promotion for TV, a movie premiere date, invitations, direct dial phone numbers, App downloads, commercial re-plays, product purchases, contact information or anything else that a client wishes to advertise on television, radio, out-of-home platforms, movie theaters or other media platforms through the wireless promotional delivery system. It is to be understood then, that the offers can be based upon client objectives or any objective which could be delivered based upon the client's desire.

Additionally, each promotion, offer, information and product sale can include an associated “action” and a pre-loaded icon associating the action. Each action represents a coupon, a PDF files, a phone numbers, a web URL, a calendar event, a purchase URL's, an application download, a contact information, a sweepstakes, a vote and map locations. Up to 10 initial actions may be supported with the advertiser selection four of the ten actions for their campaign. The WPOD system is flexible so that additional actions can be programmed in based on the advertisers requirement. It is to be understood that the information associated with the content is loaded up through a management system, and allows for input of information with respect to the terms of promotion, offer, information and product sale and their actions such as PDF files or GPS locations in an excel file, or the coupon itself, or the actual product offer and pricing itself, or the dates that the offer is good for.

Further, Unique Offer ID's can be generated for each of the above. The unique ID is applied to the content using an analysis occurring via mathematical algorithm. This then allows the WPOD to optimize the overall promotion, offer, information and product sale as many times as the advertiser would like.

Accordingly, for each client, the content that has been uploaded to the WPOD system database and the client offers are each assigned a unique ID. For example, client A is assigned a unique ID based on the digital content management system based on sequential numbers. An offer which is presented by client A would be assigned a unique ID by the offer management system and will associate the client's offer to the client's unique ID. Once the client ID and the offer ID are associated a relational database is established.

As such, the unique ID's and associated information is stored by the management system in the WPOD system database. Thus it is now possible to input changes and/or information based on the association of the unique ID's to any of the client information, content information or promotions, offers, information and product sale information. For example, it is possible according to client desire that each offer be associated with different criteria, such as geographical area, mobile application in use, location of the customer, etc. It is to be understood, of course that a national client may have different promotions, offers, information and product sales running in various geographical areas, so the location of the customer will directly impact the offer that the customer receives.

Once the client/content/offer matrix has been established and stored, in step 40 the content (e.g. commercial or program) and offers can be made live so the consumer can start to receive the promotions, offers, information and product sales information live.

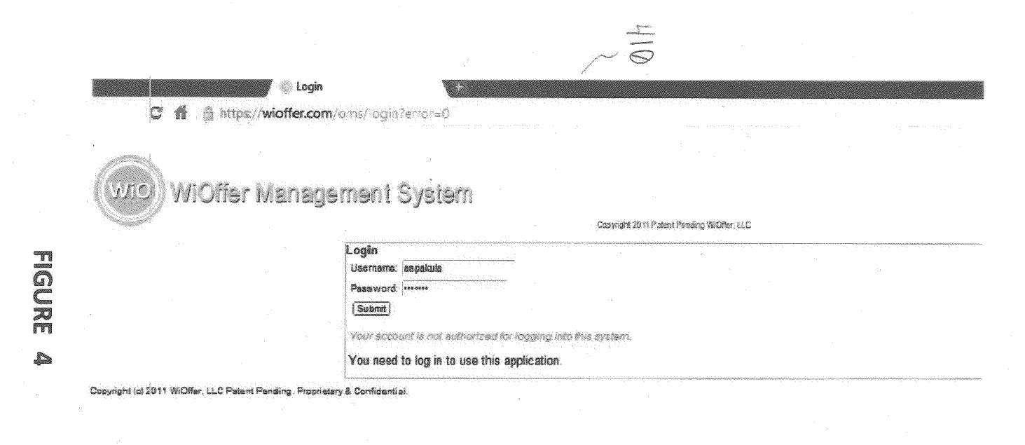

Referring now specifically to FIG. 4, a screen shot of a WPOD login screen 410 is shown. As part of step 10 of the WPOD system management process incorporating the administration and password functionality, for a user which could be a client, their agency or an administrator will access the WPOD system through the login screen 410, as shown in FIG. 4, through a WPOD system manager. As shown, a user-name and password will be required for such access. There are different levels of security which would allow different access to the WPOD system. Administrators have the highest access allowing for them to maneuver through the WPOD, whereas Clients and Agencies only have access to their reporting on their campaign activity.

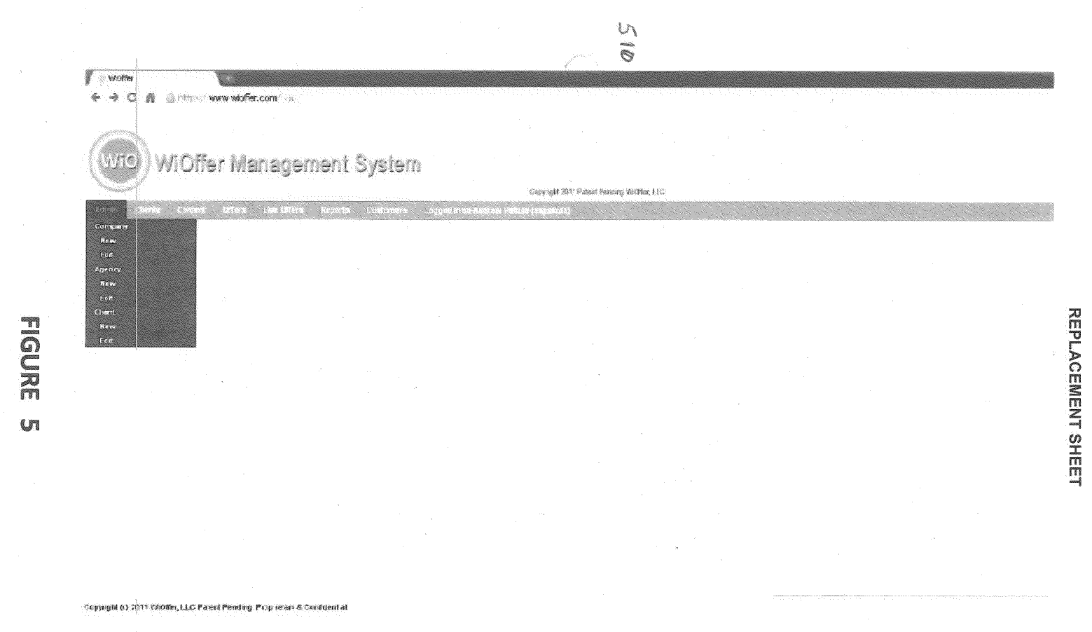

Referring now specifically to FIG. 5, a screen shot 510 of an administrative entry and/or editing drop-down menu is shown. As further required in step 10 of the WPOD system management process, the administrator shall have the opportunity to enter new or edit such information related to a company, agency or client, as shown in the administrative entry and/or editing screen 510.

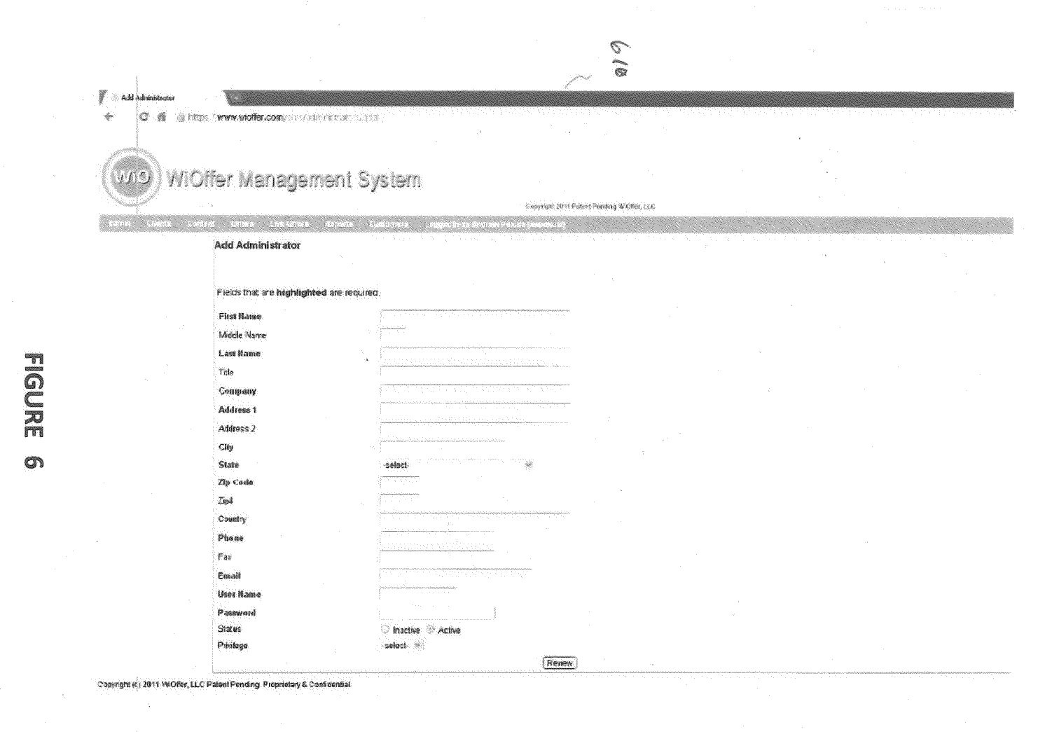

Referring now specifically to FIG. 6, a screen shot 610 of an administrator information entry screen is shown. As required by step 10, the administration step of the WPOD system management process, the administrator information can be entered in the administrative password editing screen 610. For insistence, as shown the first and last names and title of the administrator may be entered, in addition to the company name, address and other contact information. The administrator can assign username passwords and provide a hierarchical level of WPOD user protection. The administrator can assign username and passwords for clients and their advertising agencies,

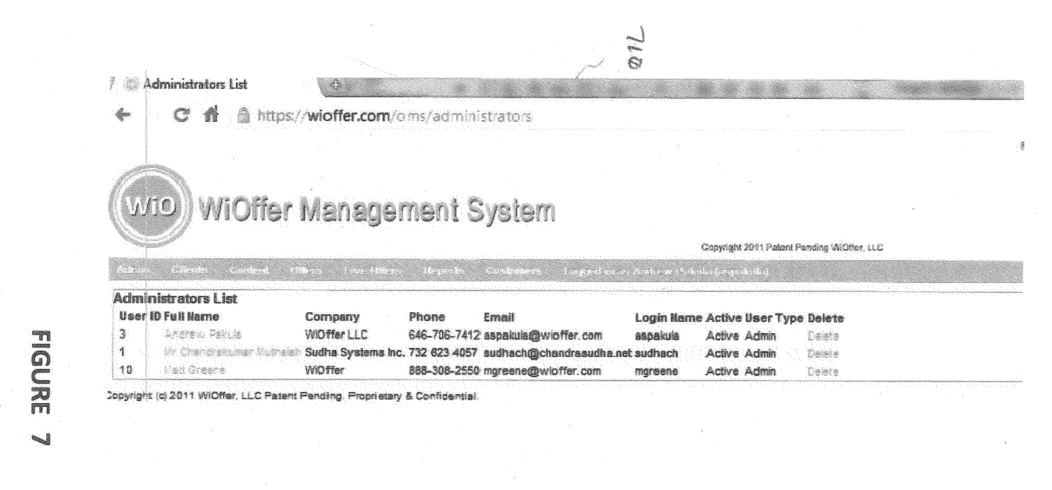

Referring now to FIG. 7, a screen shot 710 of an administrator's list is shown. Further in step 10, once the entry of the administrator's information is entered as shown by the prior figure, an administrator's list screen 710 may be produced. As shown by the exemplary list there may be various companies and administrators shown with their corresponding user ID's, company and contact information. These entries can be edited or deleted through this screen.

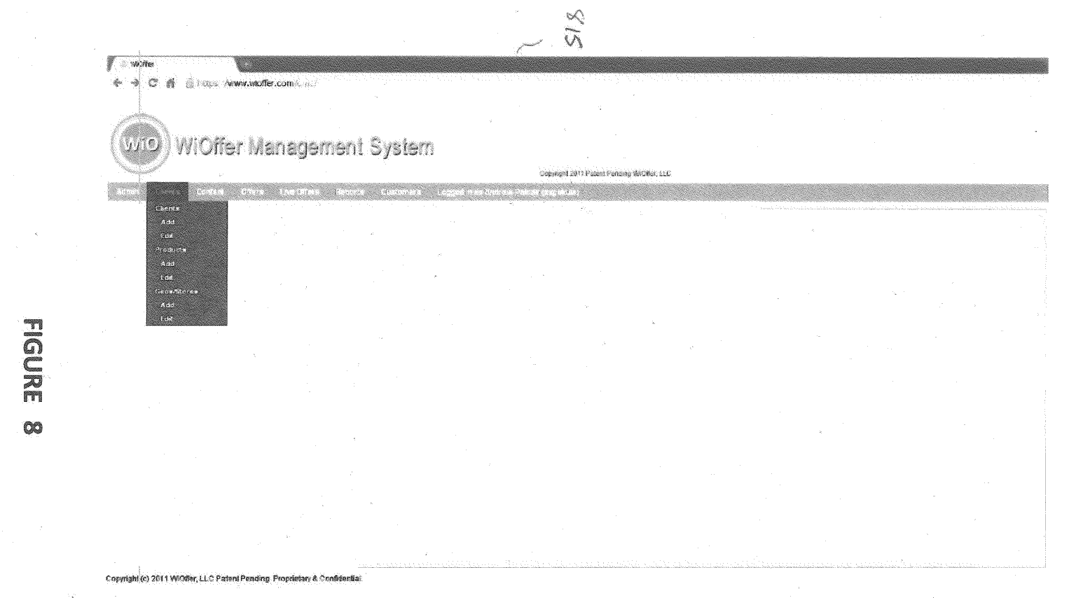

Referring now to FIG. 8, an example of a screen shot 815 of a drop-down menu for client, product and geographical information is shown. As indicated in step 15 of the WPOD system management process, and the client and product information system component 3, client information may be entered into the WPOD system. For instance, as shown the client information, product information, geography and/or store location information may be added and/or edited through this screen. The geographical information is uploaded through a CVS file based on matching field requirements provided by the WPOD system.

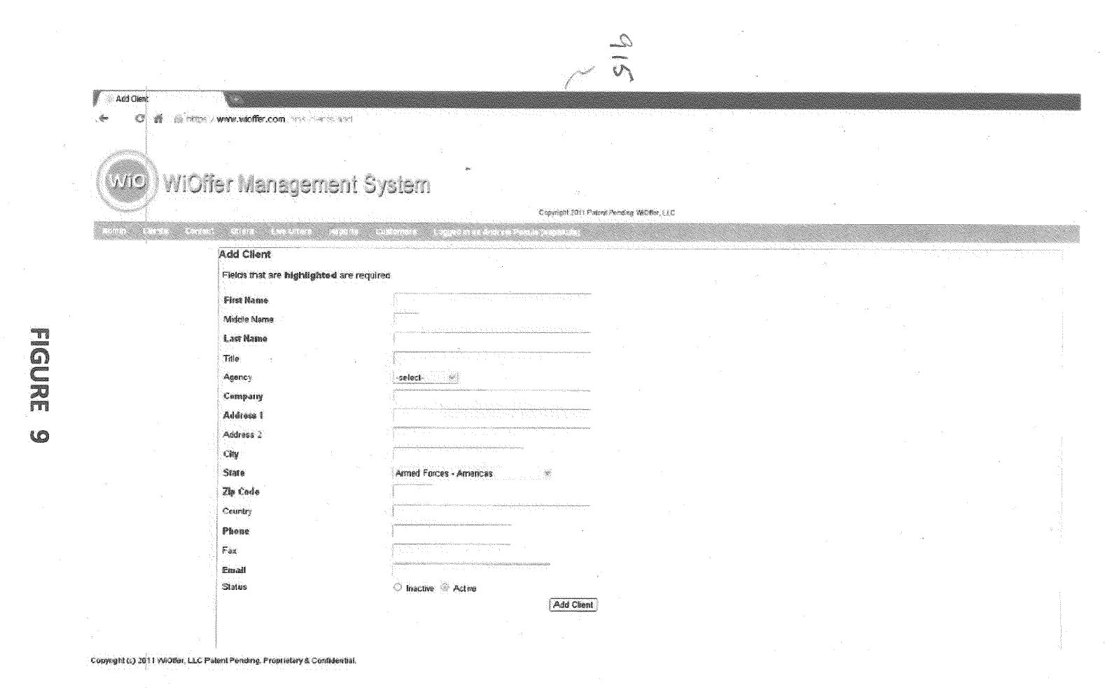

Referring now to FIG. 9, an example of a screen shot 915 of a client information addition screen is shown. Having accessed the client information upload and/or edit screen, the addition of the client information is shown such that the client's name, title, company and contact information may be entered.

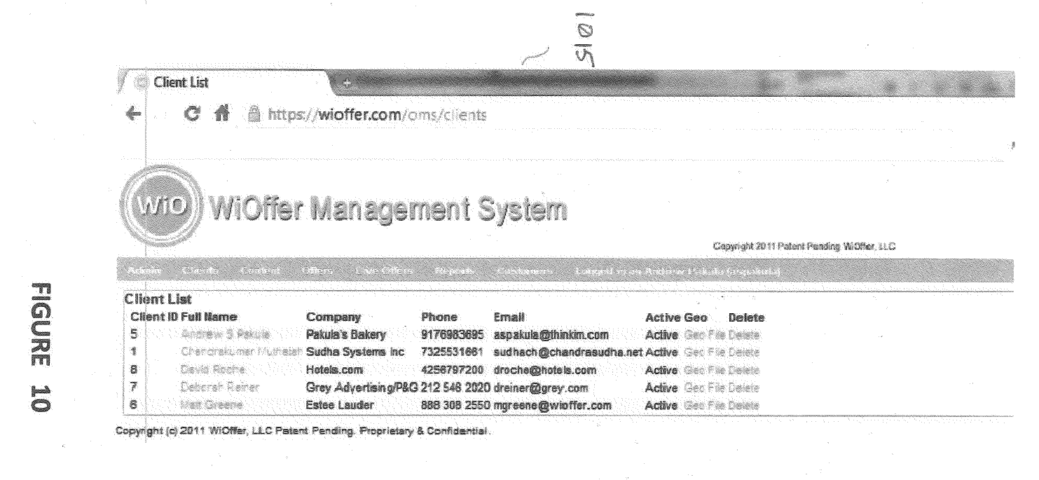

Referring now to FIG. 10, a screen shot of a client list 1015 is shown. Pursuant to the entry of the client's information through screens 815 and 915 respectively, a full client list may be promulgated. As shown in screen shot 1015 the client's name, company and contact information may be listed. This screen can be used to add, edit or delete a client.

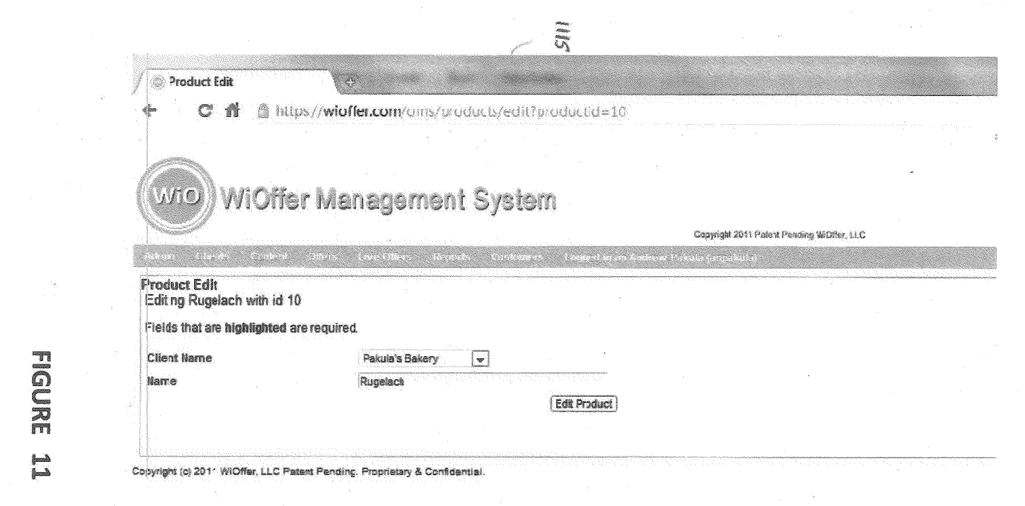

Referring now to FIG. 11, a client's product information edit screen shot 1115 is shown. Pursuant to step 15 of the WPOD system management process comprising WPOD system component 3, the client product may be added or edited through screen 1115. As shown therein there is a drop-down menu for the client name through which the appropriate client may be selected. There under the product name for that client can be entered which creates a client to product relationship. The administrator will enter the name of the product and then select the “edit product” button to begin the additional editing of the appropriate product.

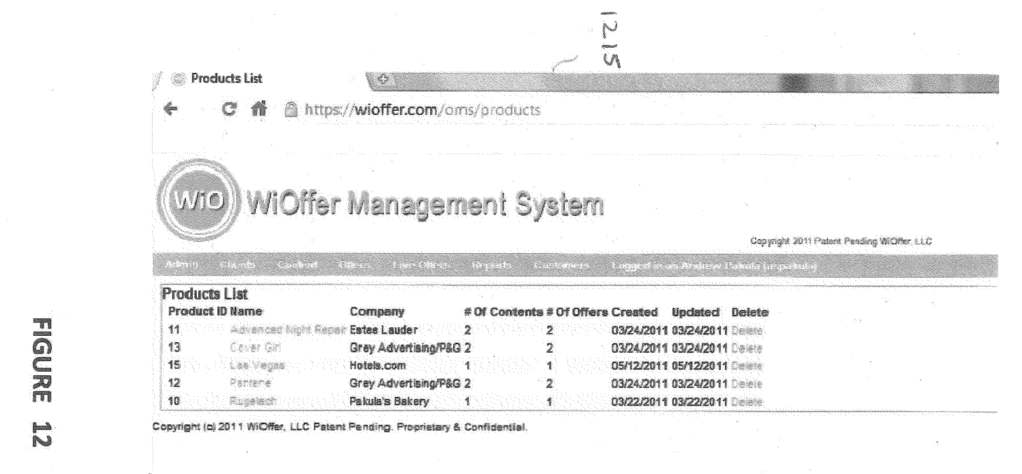

Referring now to FIG. 12, a product list screen shot 1215 is shown. Upon entry of the client information and the product information, a product list may be promulgated. As shown in the product list 1215 the product name, ID number, company and number of contents and offers and creation and update date may be shown. This screen can be used to add, edit or delete a client.

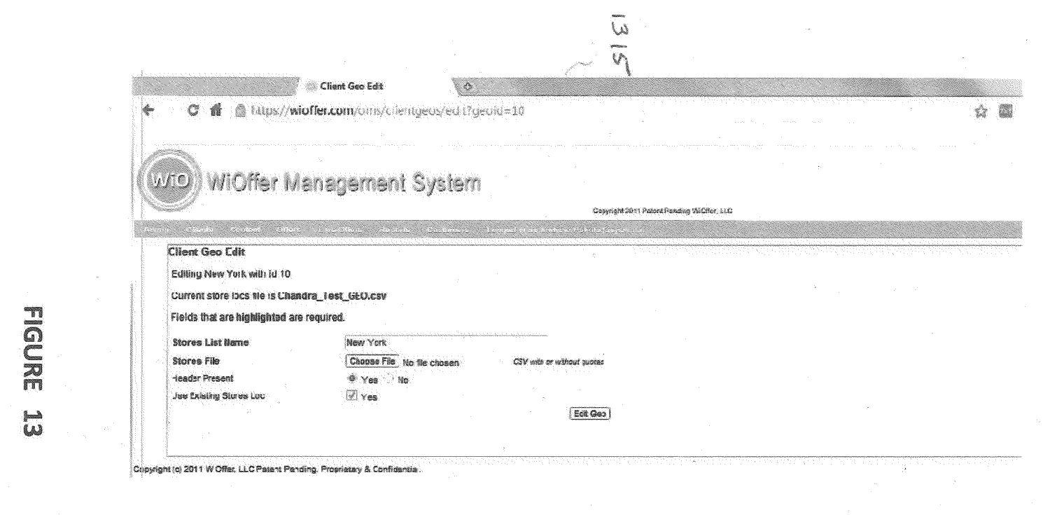

Referring now to FIG. 13, a client geography edit screen shot 1315 is shown. Further to step 15 of the WPOD system management process comprising system component 3, the geographical location file of the client may be uploaded. As shown in client geography information edit screen 1315 a client, store, name, phone number and location may be accessed and edited.

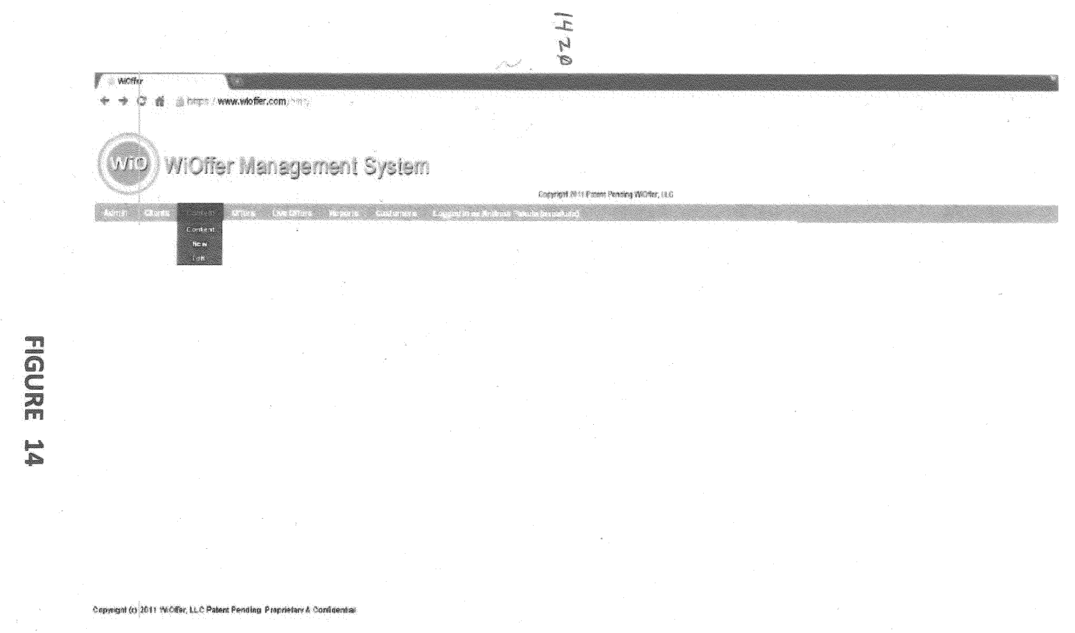

Referring now to FIG. 14, a screen shot 1420 of a content entry and edit drop-down menu is shown. As shown in the content entry and edit screen 1420 an administrator may enter new content or edit content. The content pursuant to step 20 of the WPOD system management process is that of the advertising and programming audio or video content. The accessing by the administrator of the content addition or editing screens through screen 1420 is the first step of the WPOD system management process step 20 and system component 4.

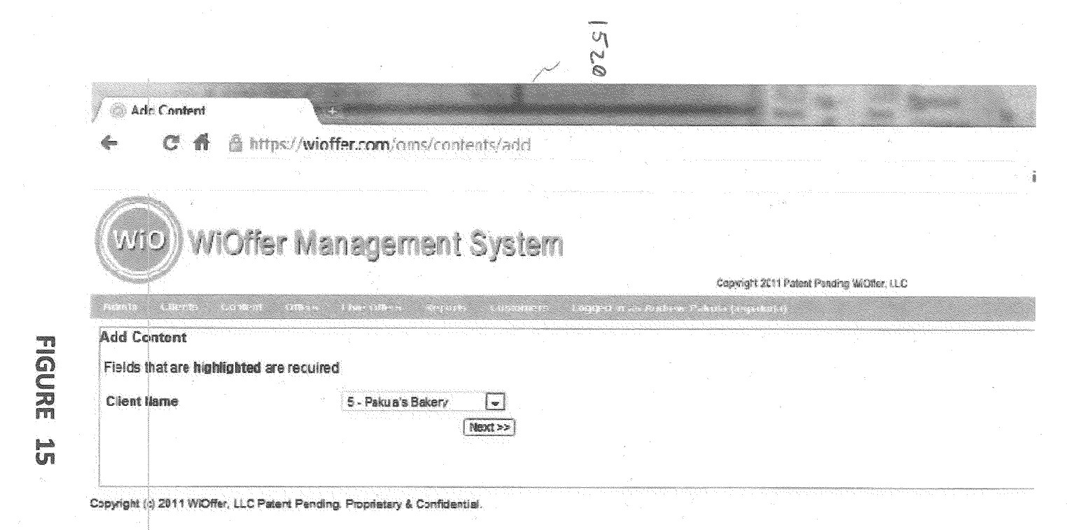

Referring now to FIG. 15, a client content and information input screen 1520 is shown. Having accessed the content edit screen 1420 as shown in screen 1520 there is a dropdown menu for selection of a client name.

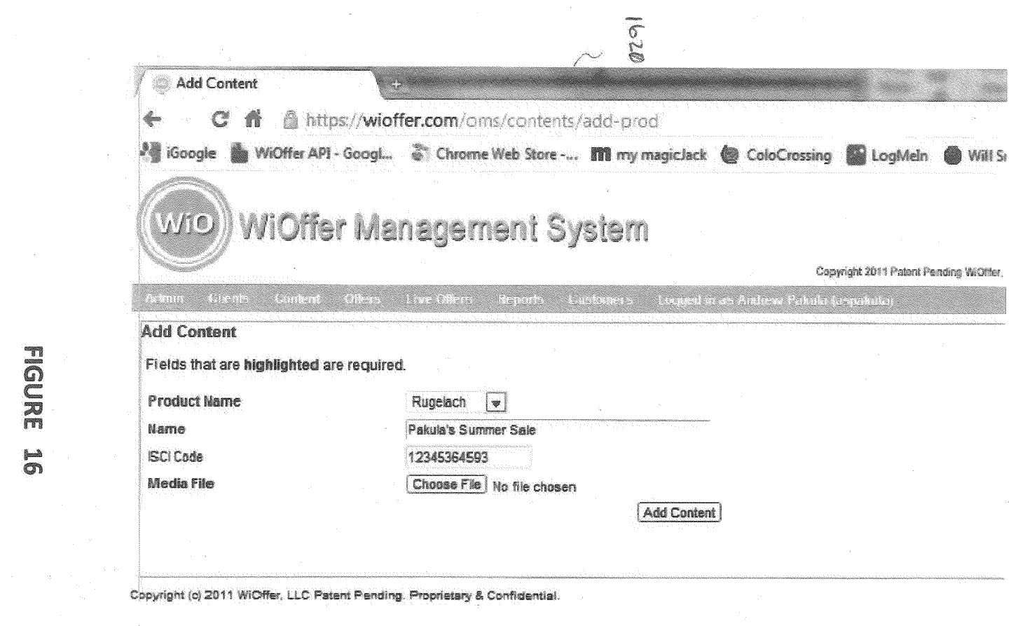

Referring now to FIG. 16, a product content and information screen 1620 is shown. As shown in screen shot 1620 there is a dropdown menu for a product name which when selected provides for entry of the content along with the corresponding ISCI code. Additionally, there is a field for content upload.

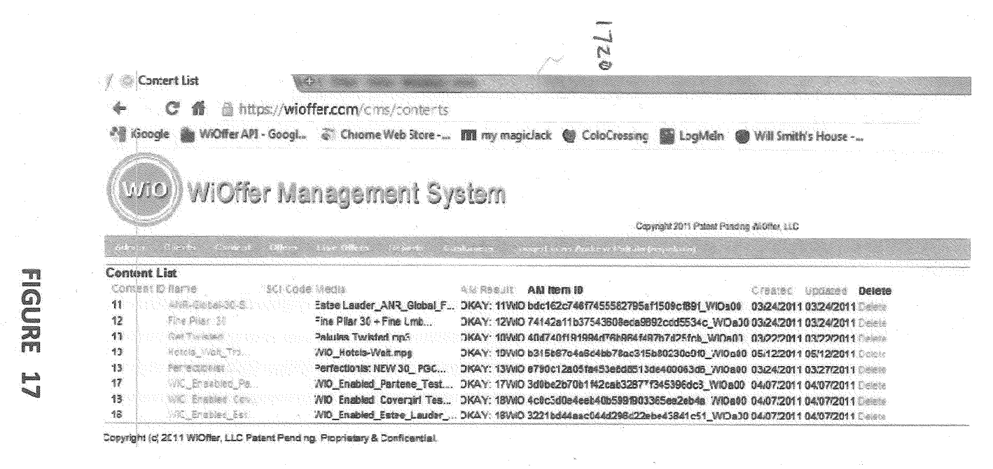

Referring now to FIG. 17, a content list screen shot 1720 is shown. Once the content has been added, a content list may be accessed through screen shot 1720. As shown therein the name of the client and the media through which the content is being offered, as well as the creation and update dates is shown. The content can also be deleted.

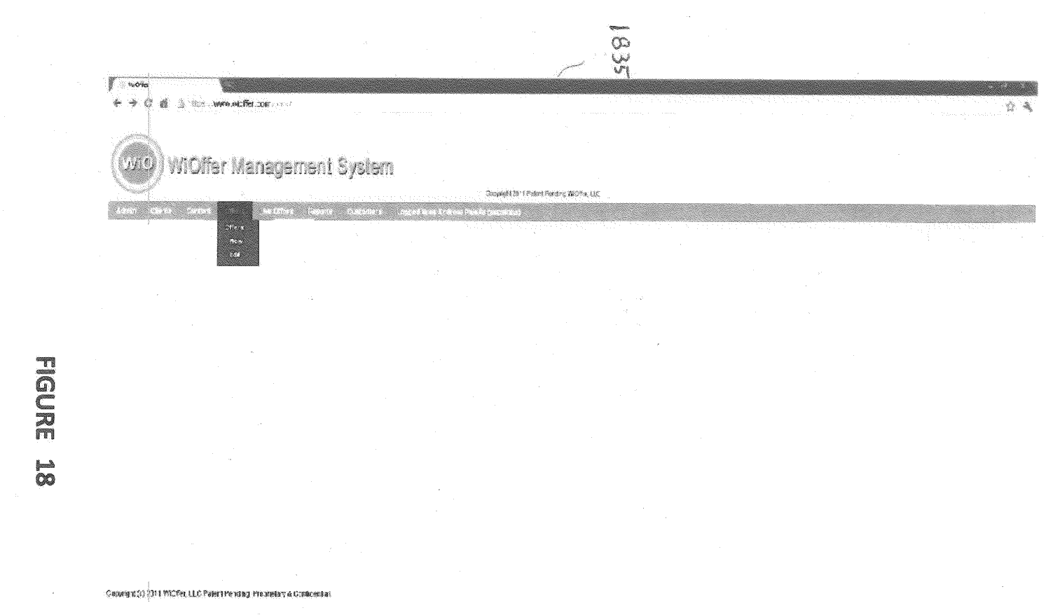

Referring now to FIG. 18, an offers input and content management screen 1835 is shown. Here an administrator may add or edit promotional information, offer information product information and or product sale information as shown. An administrator may access screen 1835 pursuant to step 35 of the WPOD system component 5.

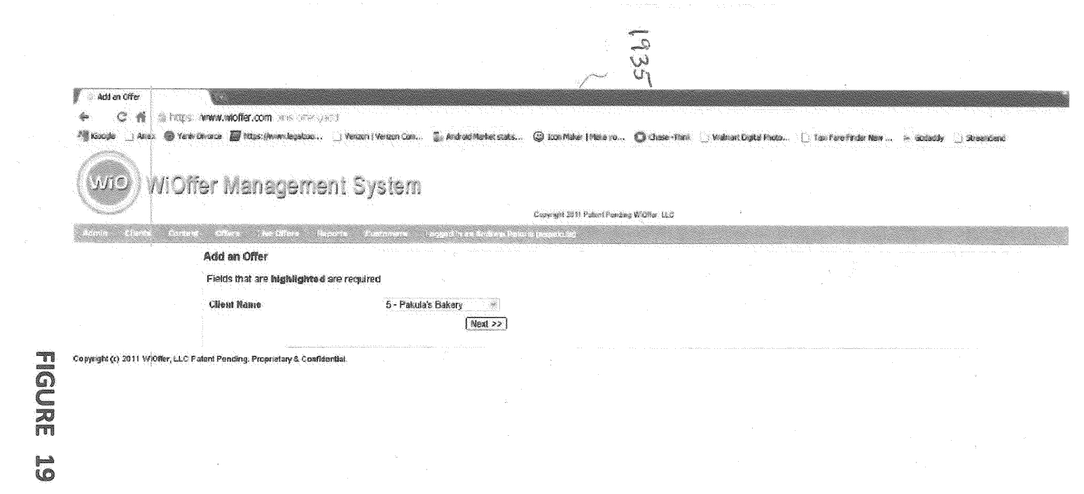

Referring now to FIG. 19, an offer information addition screen 1935 is shown. In screen 1935 administrator the first step in adding promotional information, offer information product information and or product sale information is to select the Client name from a drop down box as can be seen in screen 1935, there is a client name dropdown menu by which an administrator may select the appropriate client.

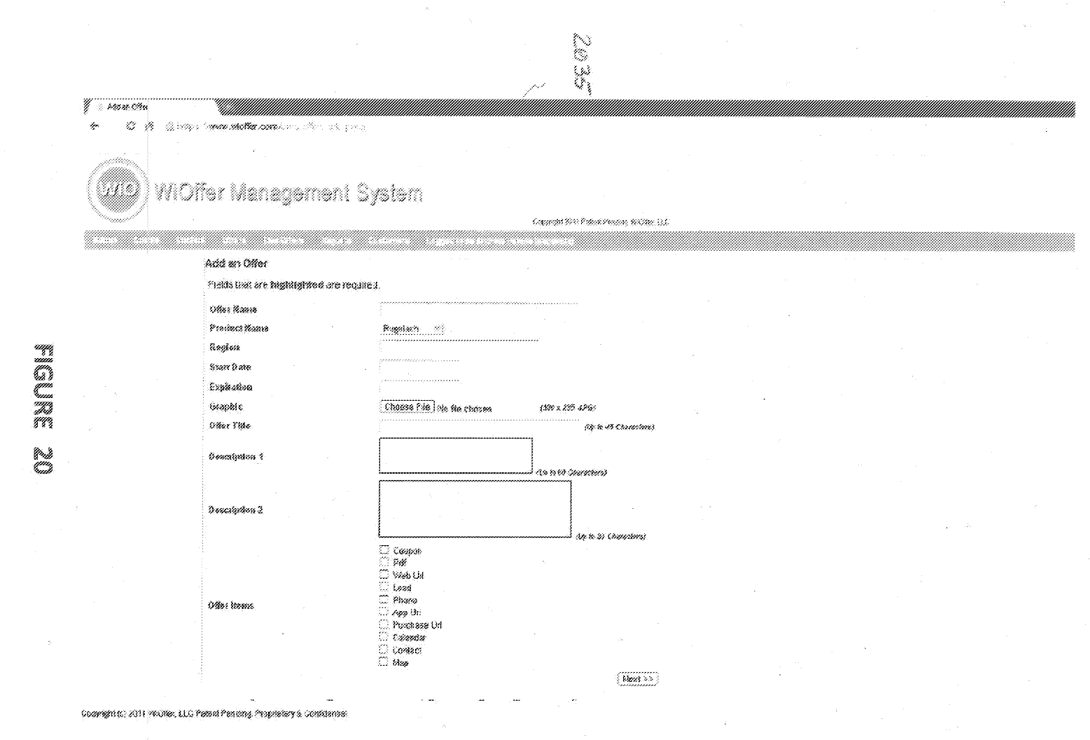

Referring now to FIG. 20, an offer input and information management screen 2035 is shown. In screen 2035 the administrator may enter the name of a promotional, offer, information and or product sale information with a product name selected through a product dropdown menu. Included would be the region where the [product is offered, the start date and expiration date of the product offer and public title of the offer may be entered as well. The product offer input screen also includes fields to add a product title, and two descriptions of the product offer, and a listing of what offer actions to be communicated to the customer which will appear on the WPOD wireless device when delivered.

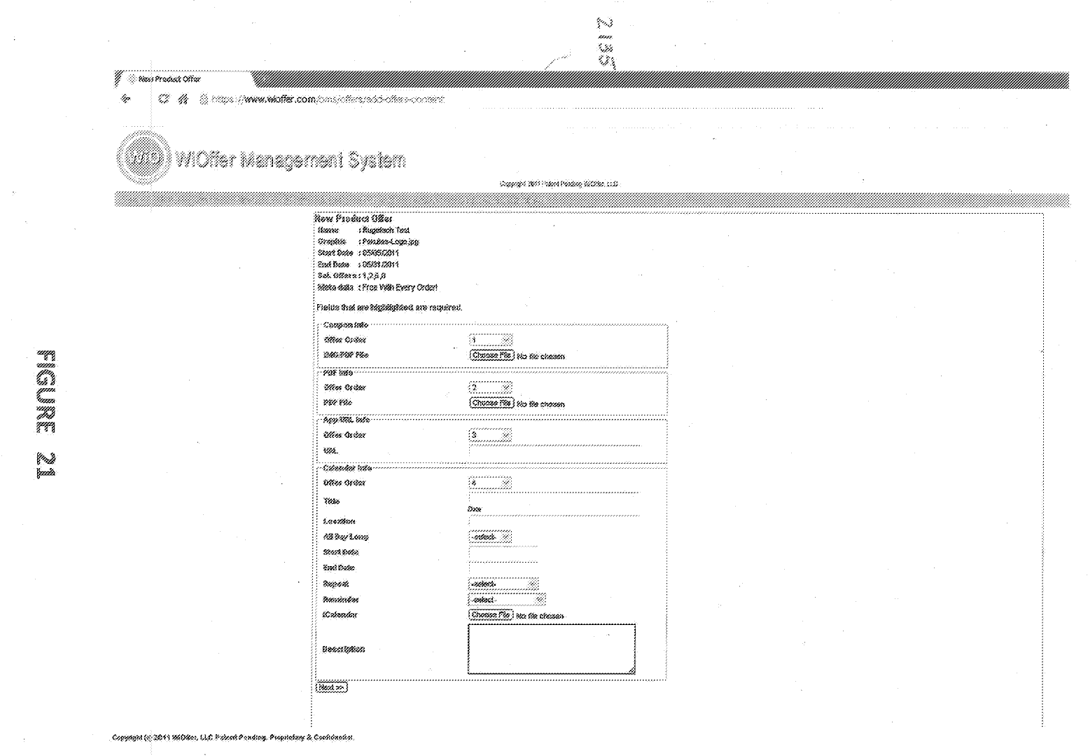

Referring now to FIG. 21, a new product offer information edit screen 2135 is shown. In screen 2135 an administrator may edit the product offer information further. As shown, for example, a new product offer may be edited by its coupon, PDF application or URL, or calendar information.

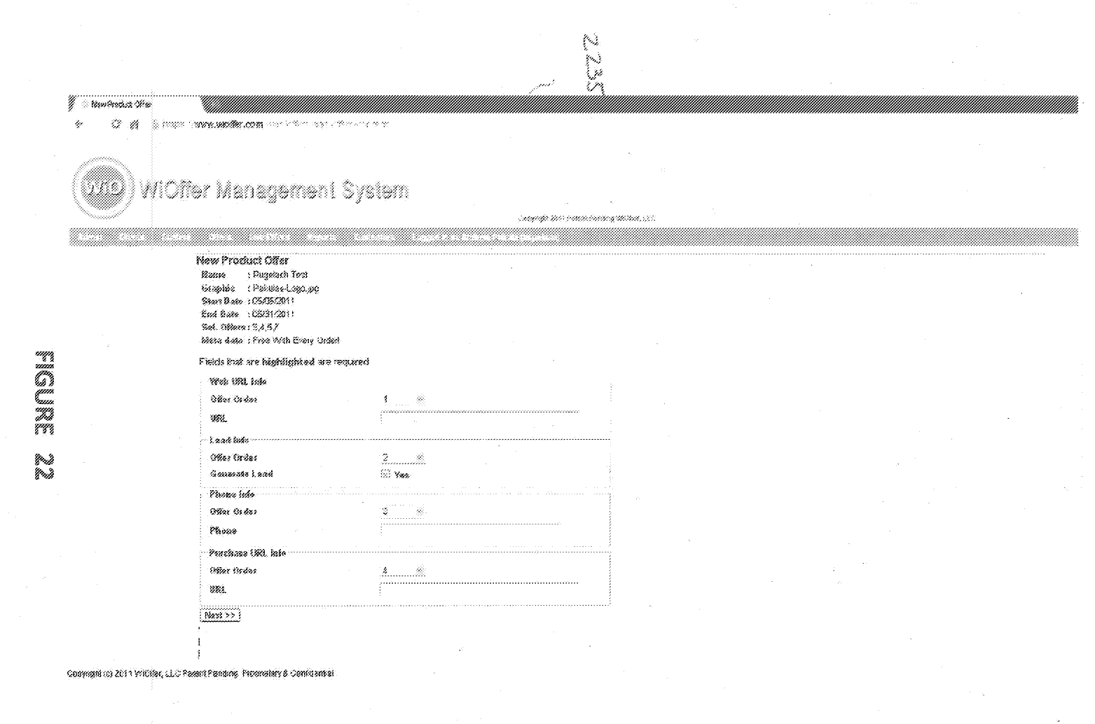

Referring now to FIG. 22, a new product offer information entry screen 2235 is shown. As shown in screen 2235 an administrator may enter information relating to the website URL, opt-in lead, phone and purchase URL information.

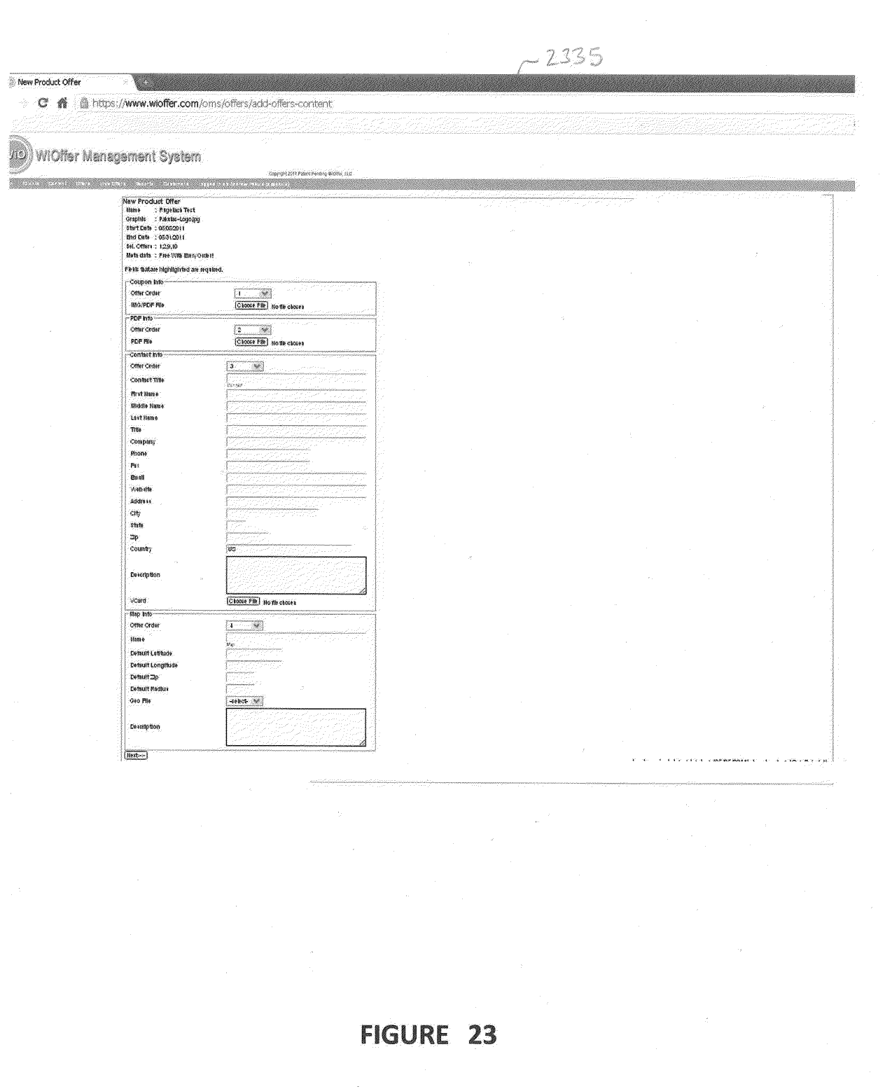

Referring now to FIG. 23, a new product offer information entry screen 2335 is shown. In screen 2335 an administrator may enter information related to the coupon, PDF, contact and map information to the product.

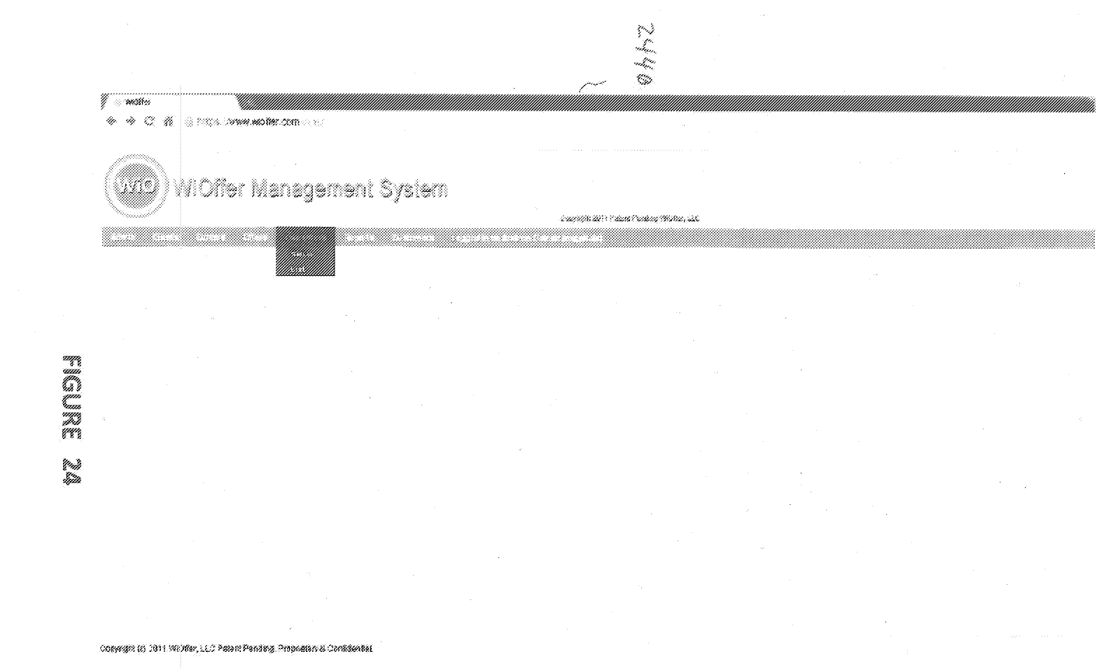

Referring now to FIG. 24, a dropdown menu for the setup and listing of live offers screen 2440 is shown. Pursuant to step 40 of the WPOD system management process which correlates to WPOD system component 6, the live offers screen 2440 allows an administrator to associate and/or edit content and product offers.

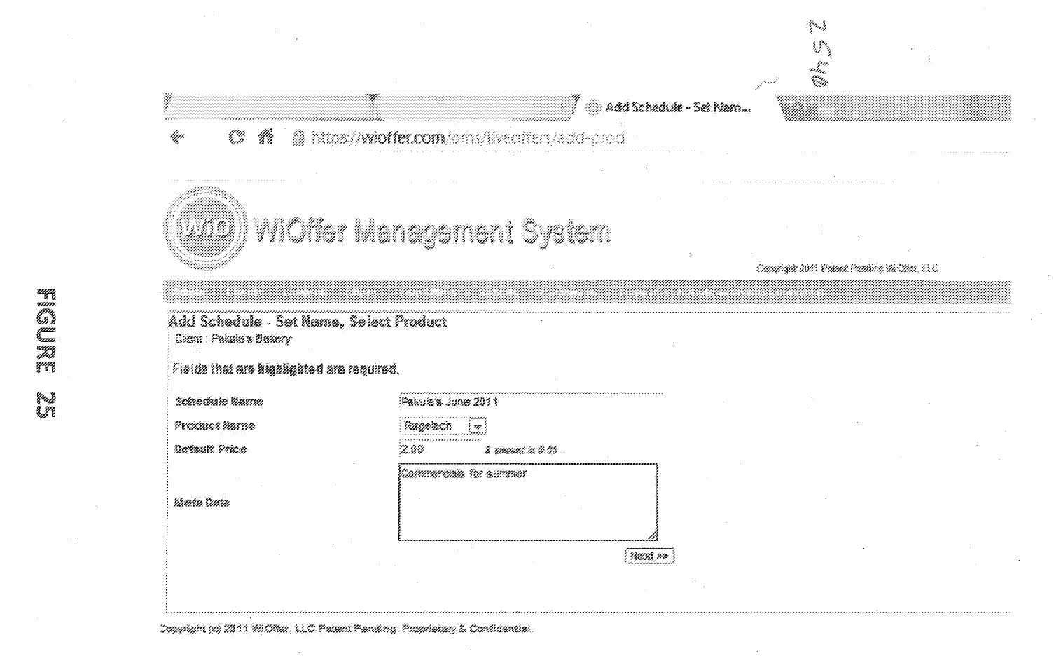

Referring now to FIG. 25, an offer schedule information entry screen 2540 is shown. As shown in screen 2540 an administrator can schedule or edit a live offer by choosing the product through a product dropdown menu including the price for each action and a description of the offer to be associated with the product offer.

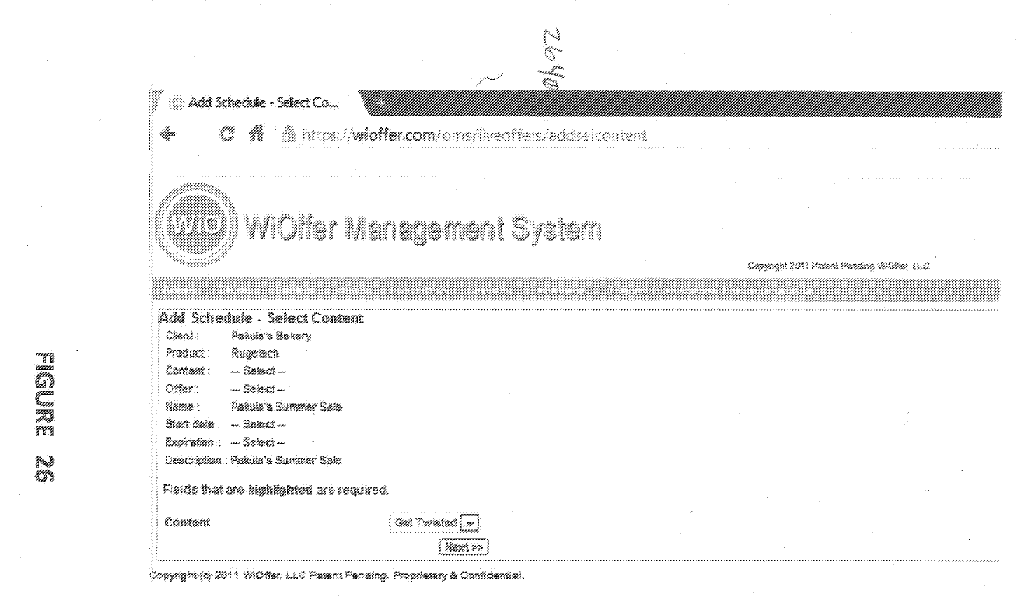

Referring now to FIG. 26, an offer schedule content information entry input screen 2640 is shown. As shown, an administrator may select content for the schedule the selection dropdown menu.

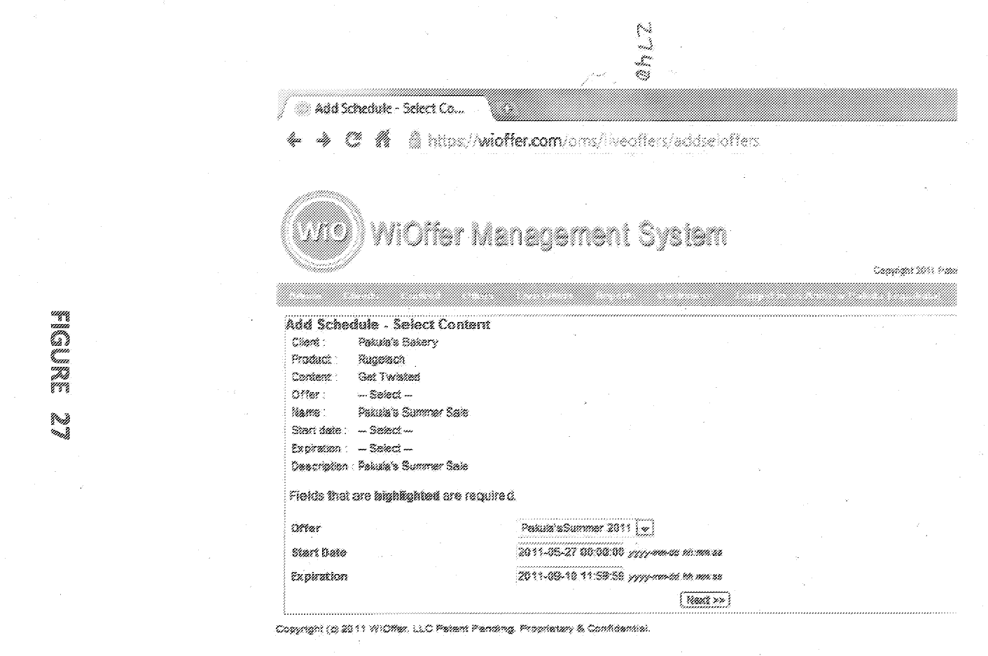

Referring now to FIG. 27, a content information entry screen 2740 is shown. In screen 2740 the content that was selected in screen 2640 now shows the particular offer associated with said content and the start and expiration date for that offer can now be added. Further in screen 2740 various offers may be accessed through the offer dropdown menu.

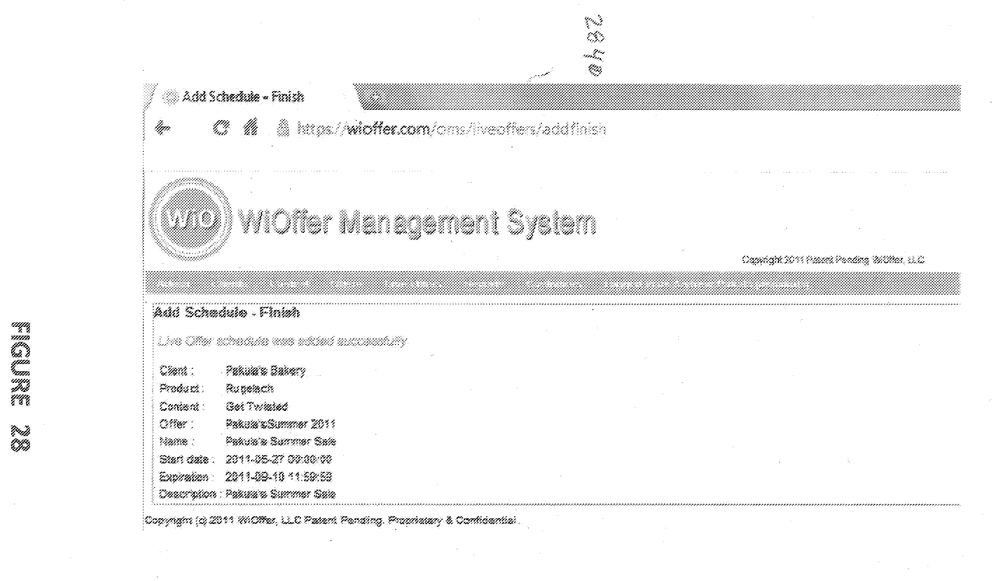

Referring now to FIG. 28, a schedule information entry completed screen 2840 is shown. Here the client name, product name, content associated with such product and the offer name associated with the content is shown. Further the start and expiration date and a description of the named offer is shown. This screen indicates that a live offer schedule was successfully edited and added to the WPOD system.

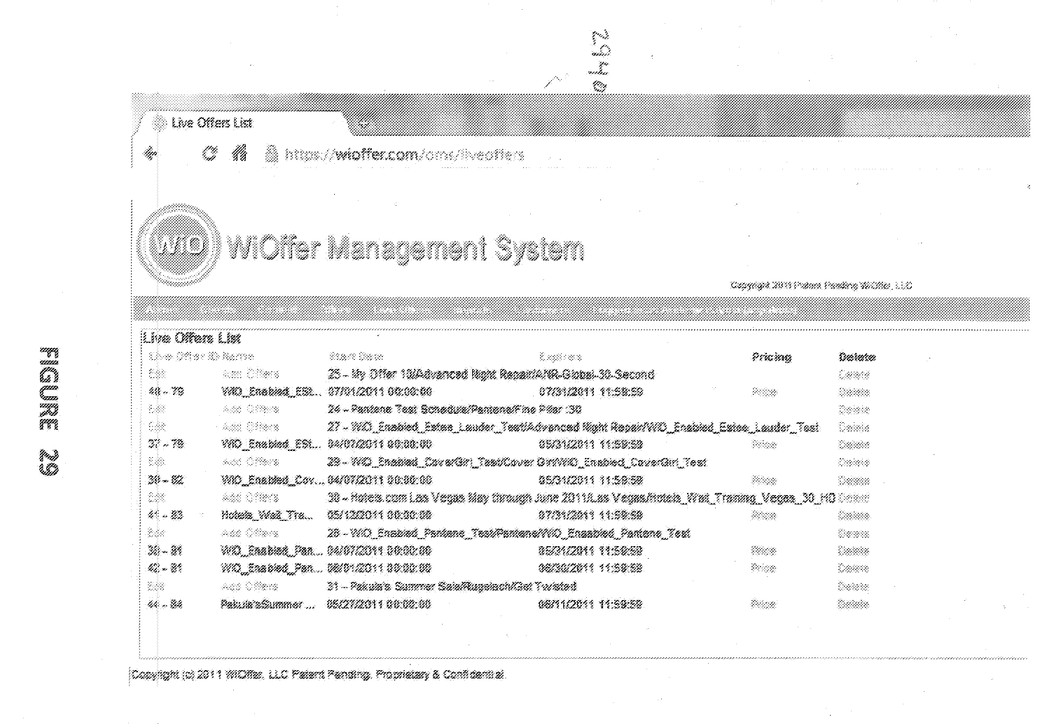

Referring now to FIG. 29, a live offers list screen 2940 is shown. As shown in screen 2940 an administrator may access a list of live offers. The live offers list shows the name of the live offer and the start and expiration date of the offer. The screen also allows you to click through to edit and/or add and or delete offers.

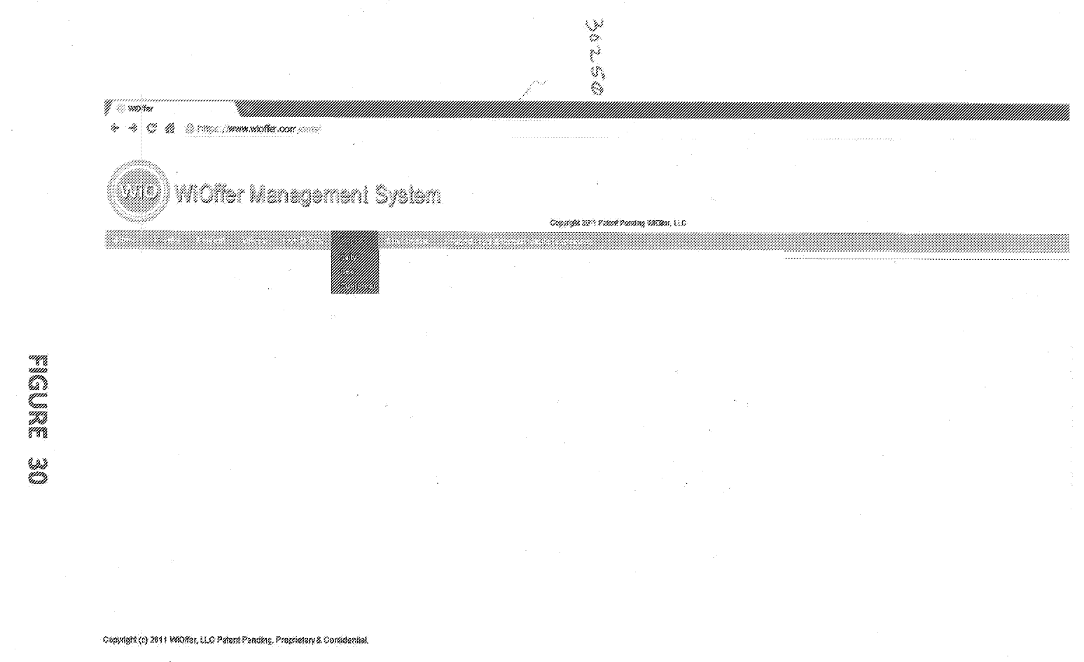

Referring now to FIG. 30, a reports dropdown menu screen 30250 is shown. The reports dropdown menu 30250 is utilized by an administrator in step 250 of the WPOD system management process, which correlates to WPOD system component 7. Through the reports dropdown menu screen 3250 the administrator may access daily/geographic and/or customer reports which reports on the activity of the delivered offers to consumers on their WPOD wireless device.

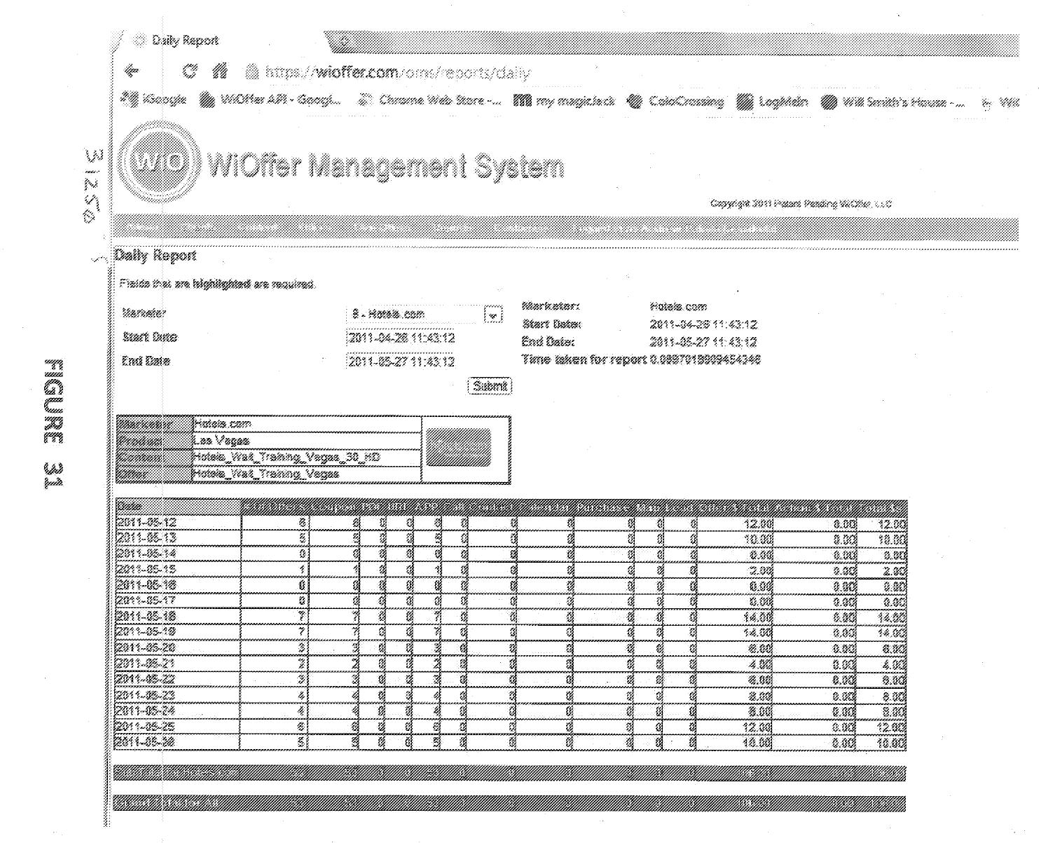

Referring now to FIG. 31, a daily report screen 31250 is shown. The daily report provides the administrator with a report showing the marketer, which may be selected through a marketer dropdown menu and allows a report to be run from a start to an end date time period. Once run the report shows the number of offers delivered and the associated actions for that offer and other information according to the date within the time period selected.

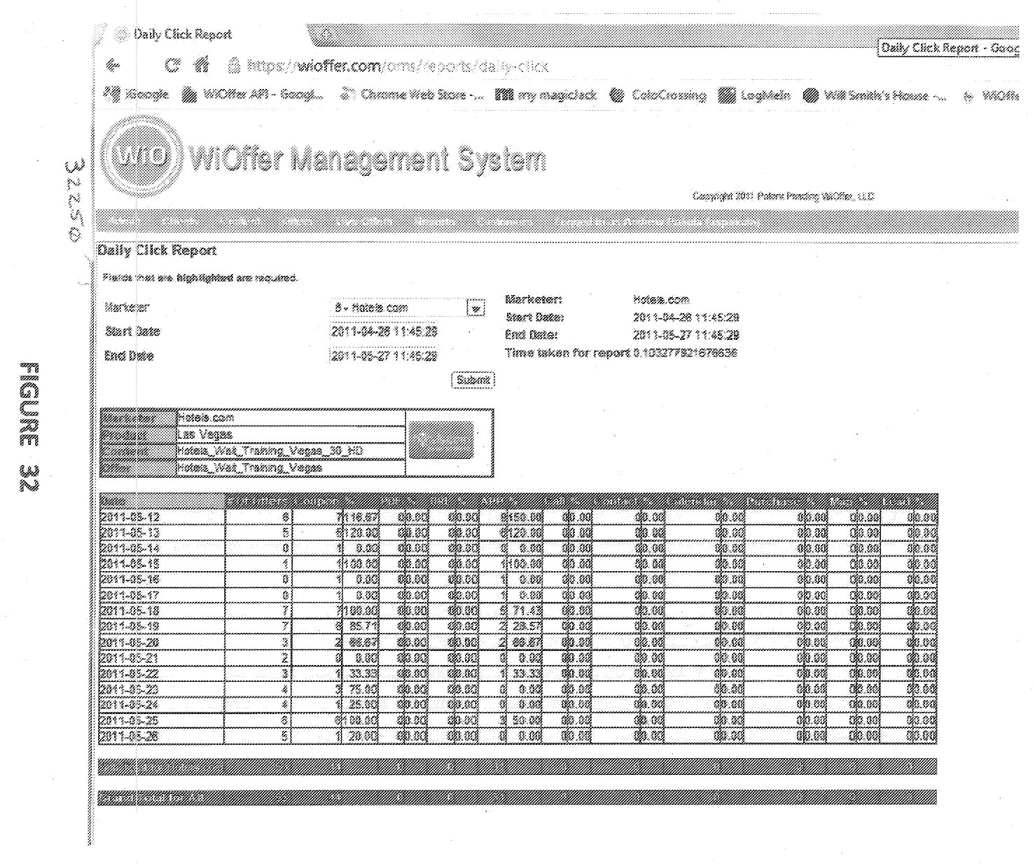

Referring now to FIG. 32, a daily click report screen 32250 is shown. The daily click report screen 32250 allows for the administrator to choose the appropriate marketer from a dropdown menu and to enter the start and end dates for the report. The report period shows by date the number of offers that were click-on or acted upon.

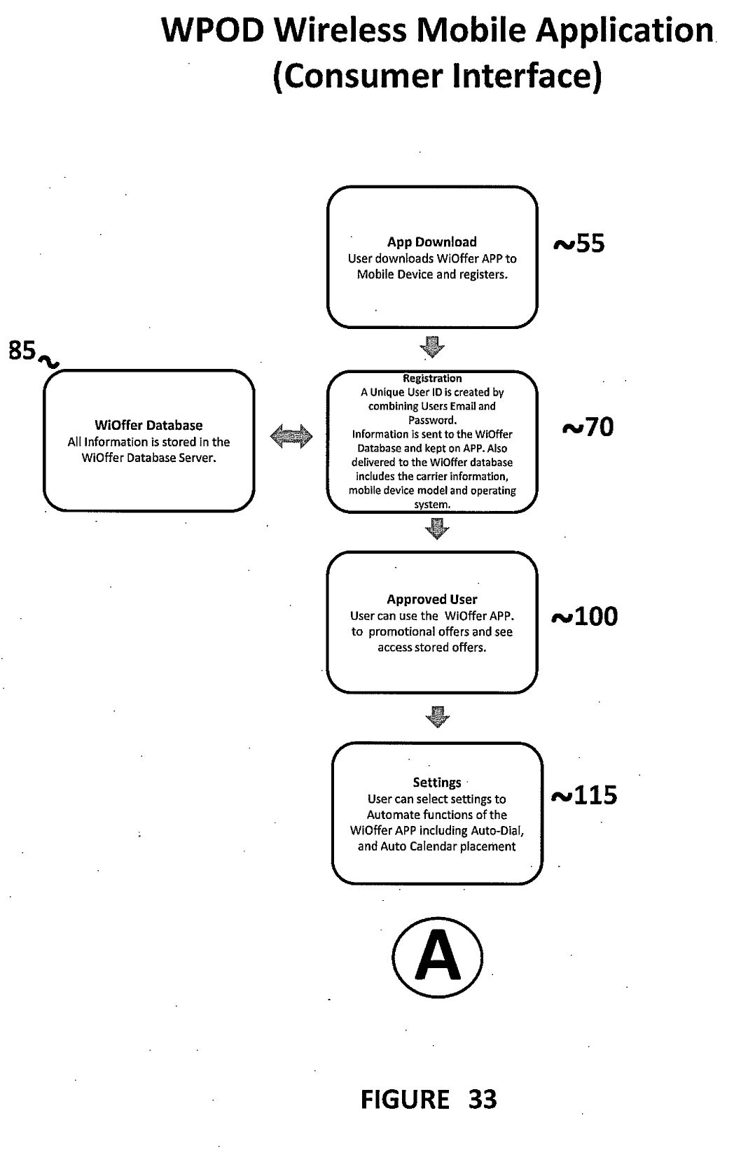

Referring now specifically to FIG. 33, the present invention's mobile application and consumer interface is shown. In step 55, a user downloads the WPOD system application for the user's wireless device and registers with the wireless promotional delivery system. The registration process will allow the system to identify the user and allow for the user to access the WPOD system. For example, registration may minimally request the user's cell phone number and email address, or may request further information such as name, address, and/or billing information. It is to be understood, of course that download of the WPOD system application is not to be limited to the user's mobile device, but may also include a smart phone, tablet, desktop computer, laptop or any other electronic device that the user can use to receive content and/or offers.

Once registration and downloading of the WPOD system application is completed by the user, in step 70 the WPOD system assigns a customer ID number to the user which is housed in the WiOffer WPOD database in step 85.

Having now registered the user and assigned a customer number, the user may use the WPOD application to obtain promotions, offers, information and product sales through cable/broadcast or broadband television, radio or other electronic devices that play video and audio content in step 100. Use of the WPOD system application is accomplished when the user sees a commercial or piece of programming that the user is interested in and the user simply starts the application or such application may be started on its own, and allows the application to acquire the audio content. In step 115, once the WPOD application is downloaded the user registers, the registrant can change the settings in the WPOD app which can automate some of the WPOD action processes.

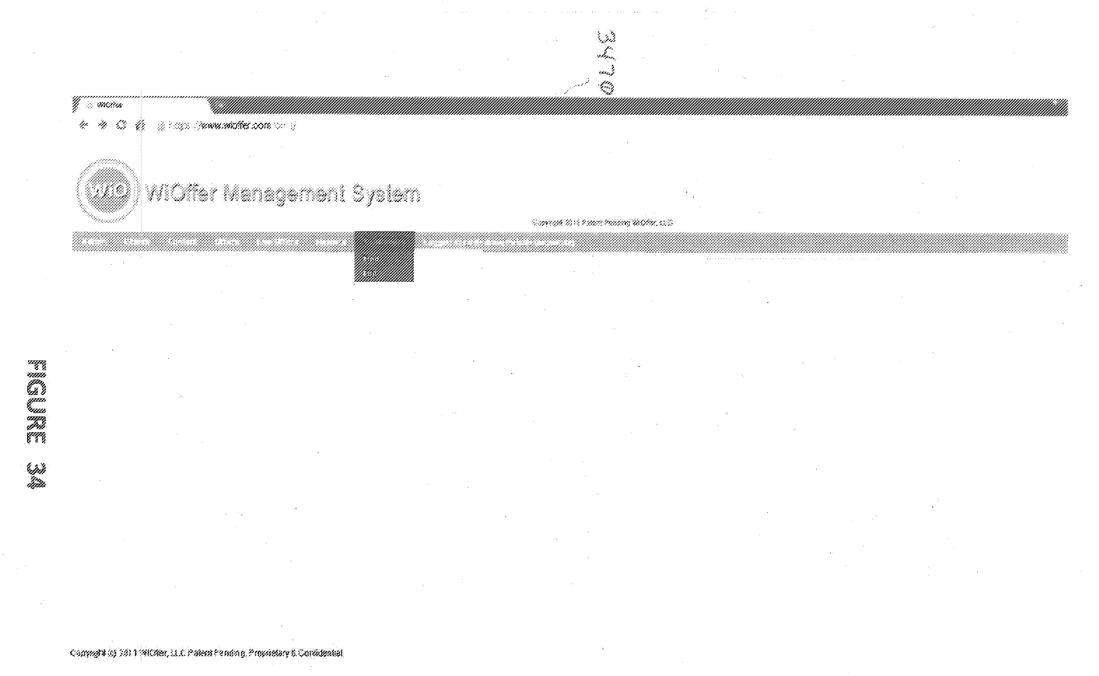

Referring now to FIG. 34, a dropdown menu of customer search and edit functionality screen 3470 is shown. In screen 3470 a dropdown menu for the purpose of searching for and/or editing registered customer information is shown.

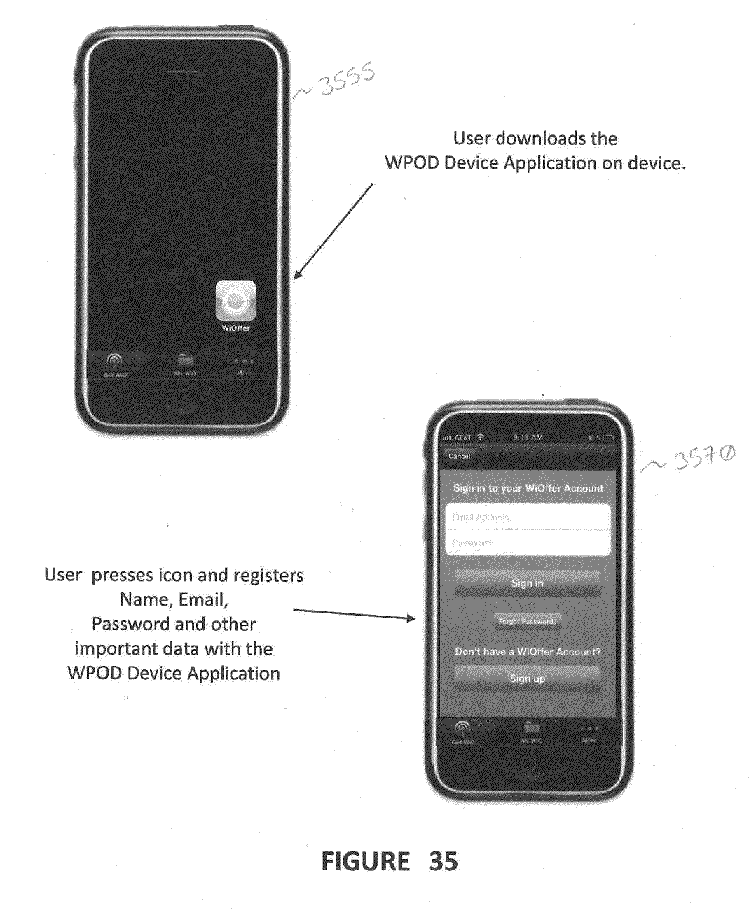

Referring now to FIG. 35, portable handheld wireless devices showing functionality screen shots 3555 and 3570, respectively, are shown. These screen shots coincide with the WPOD system component 8 that is the mobile wireless application interface. Screen shot 3555 shows the WPOD device application having been downloaded by the customer on their wireless device in step 55. Screen shot 3570 shows the sign-in page and/or sign-up page for the WiOffer account registration required by step 70.

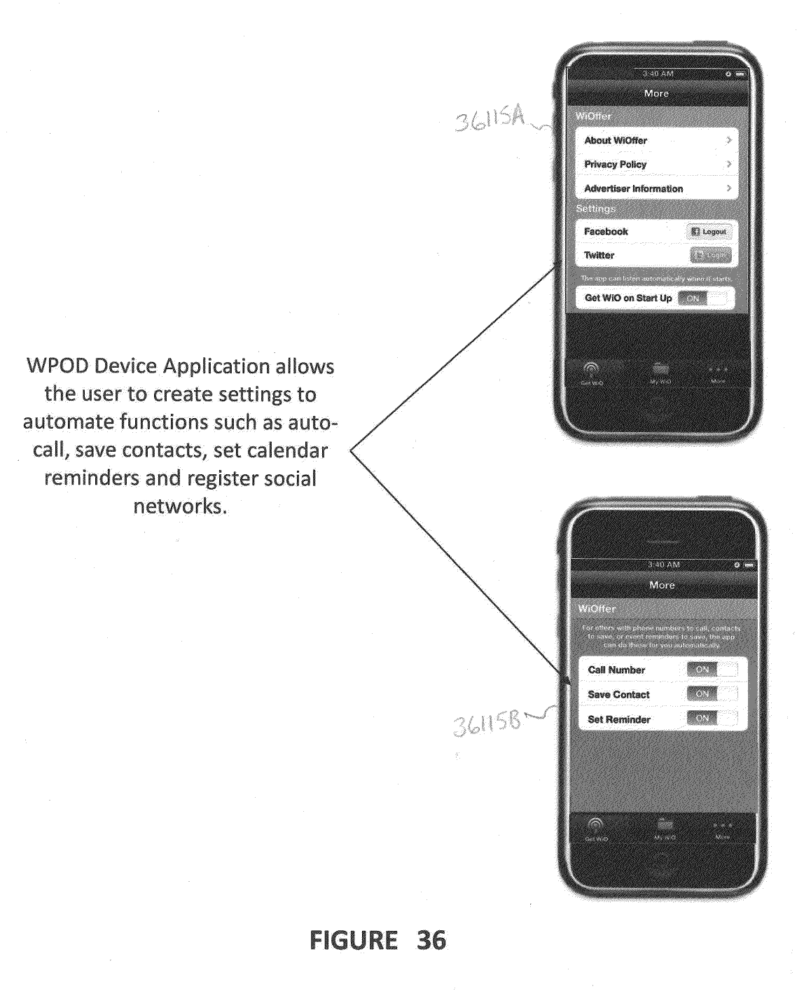

Referring now to FIG. 36, two portable wireless devices showing the functionality screen shots 36115A and 36115B, respectively, are shown. In screen shot 36115A the user can view information about the WPOD system as to WiOffer itself, the privacy policy and receive advertiser information. Screen 36115B shows that the user may automate such functionality as the auto phone call, auto contacts to save and the ability to auto set calendar reminders by setting the fields Call Number, Save Contact and Set Reminder features to ON or OFF. Through such functionality screen setting, the WPOD device application resident on the portable handheld wireless device allows the user to create settings to automate functions such as auto call, save contents, set calendar reminders and register social networks.

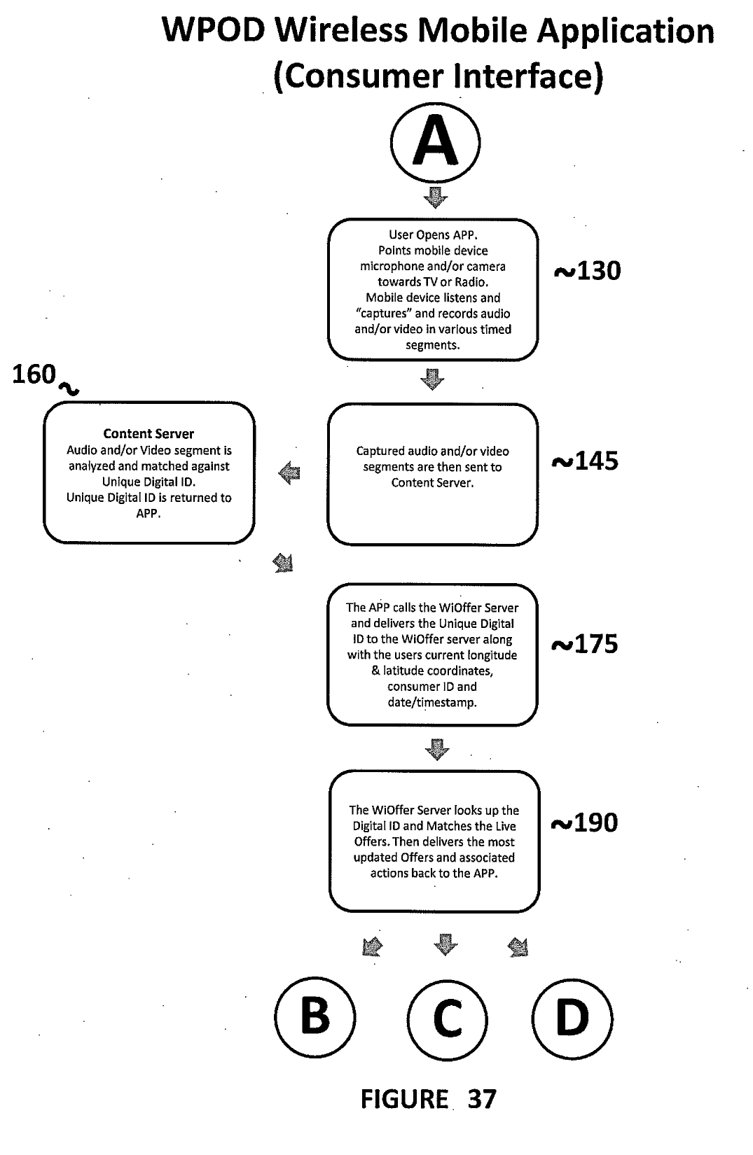

Referring now specifically to FIG. 37, the lookup and delivery processing component of the WPOD system is shown. The consumer in step 130 activates the WPOD application and the WPOD application begins to acquire the audio sample in no less than six seconds. The audio sample, or any other ingestion method, is sent to the WPOD content server in step 145 and in step 160, the audio sample is analyzed and deciphered and matched with the associated unique digital ID. In step 175, the associated unique digital ID is then delivered back to the WPOD Application where it is then redirected to the WPOD database server along with the Longitude and Latitude GPS coordinate of where the consumer is located at the time of the audio acquisition, along with the registrants ID and date and time stamp. Upon receiving the unique digital ID, the longitude and latitude information, the registrants ID and the date and time stamp, the offer and actions associated with the unique digital ID is then delivered wirelessly to the WPOD application for viewing in step 190.

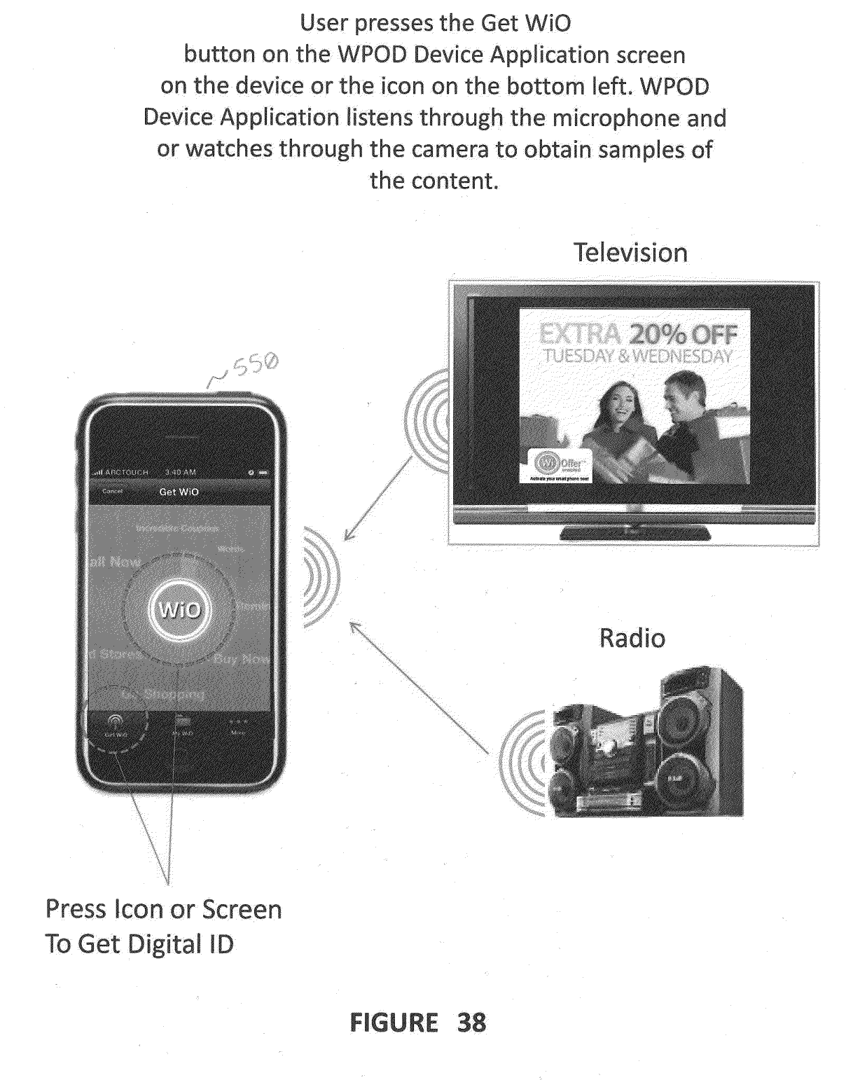

Referring now to FIG. 38, a portable handheld wireless device 550 is shown being used in conjunction with a television (no reference number) and a radio (no reference number). FIG. 38 references step 130, correlating to the WPOD system component 8, of the WPOD wireless mobile application (consumer interface), and as such the user presses the get “WiO” button on the WPOD device 550 application screen. Such activation of the WPOD device application causes the application to listen through the microphone and/or watch through the camera to obtain samples of the content of the audio and/or video content.

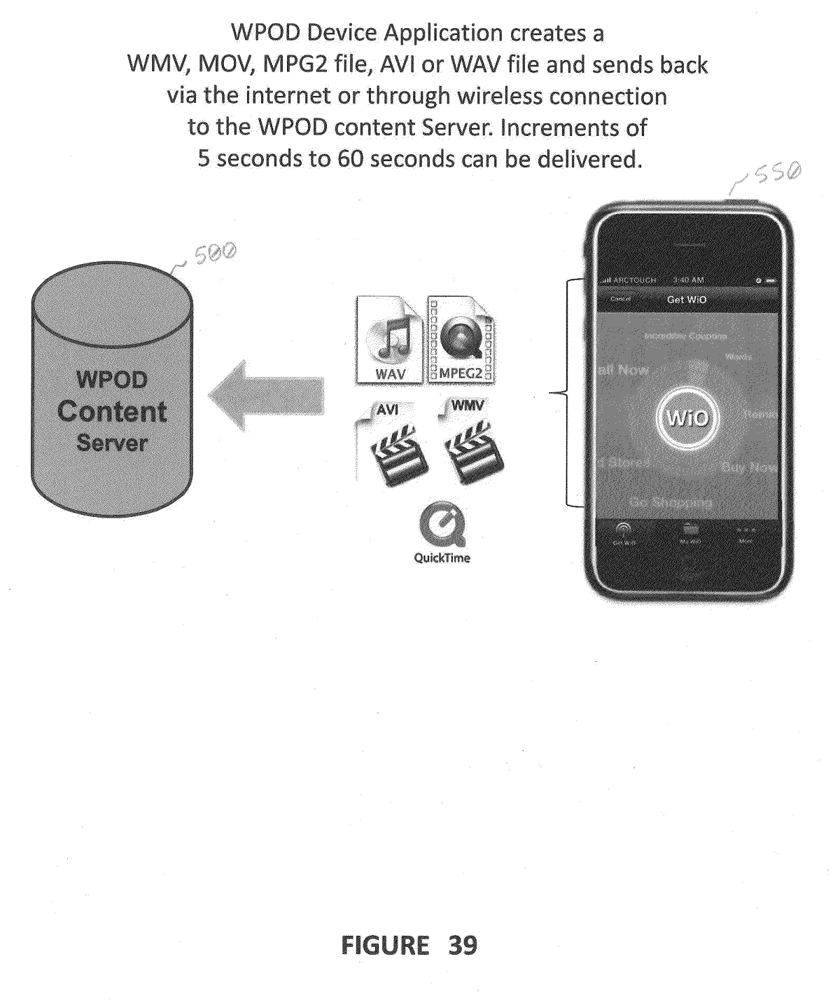

Referring now to FIG. 39, the portable handheld device 550 is shown creating various files of the audio and/or video capture and transmitting such files to the WPOD content server 500. The file creation capability of the WPOD device application is such that it can create WMV, MOV, MPG2, AVI or WAV files and operates to send such files to the WPOD Content Server database 550 via internet or wireless connection. FIG. 39 correlates to step 145 of the WPOD wireless mobile application (consumer interface) of WPOD system component 8.

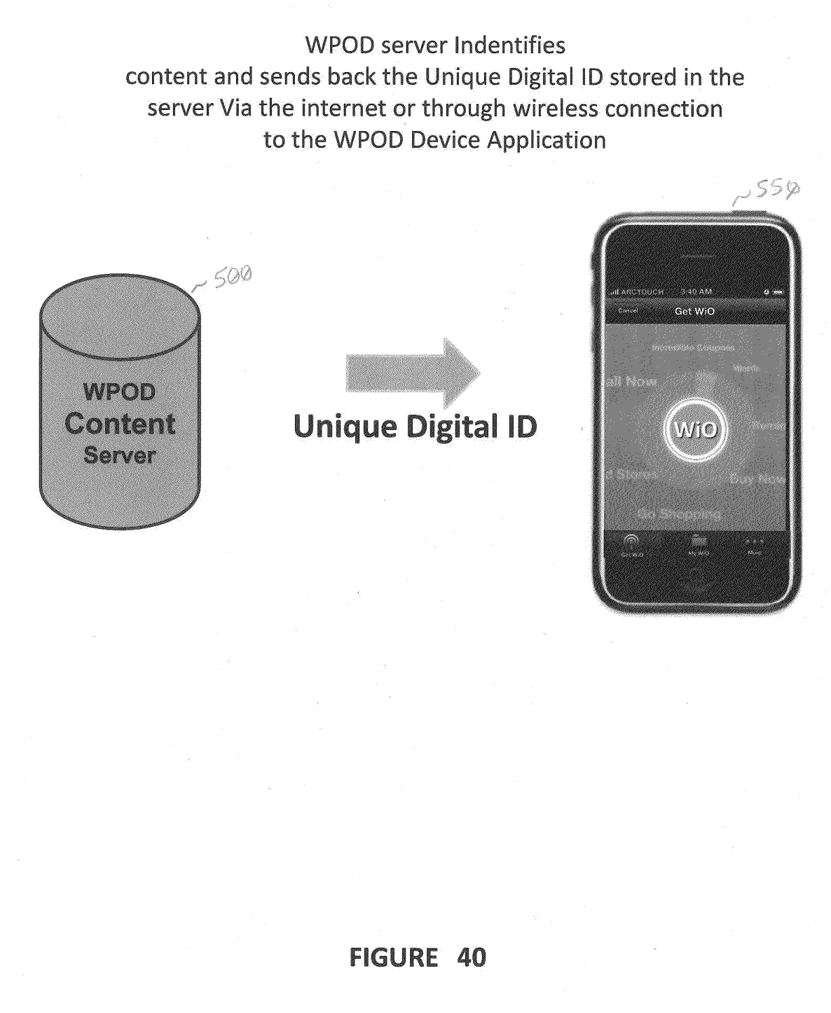

Referring now to FIG. 40, the WPOD content server 500 identifies the content in step 160 of the WPOD wireless mobile application (consumer interface) and sends back a unique digital ID 501 stored in the server via the internet or through wireless connection to the WPOD application on the device 500 correlating to step 175 of the WPOD wireless mobile application (consumer interface).

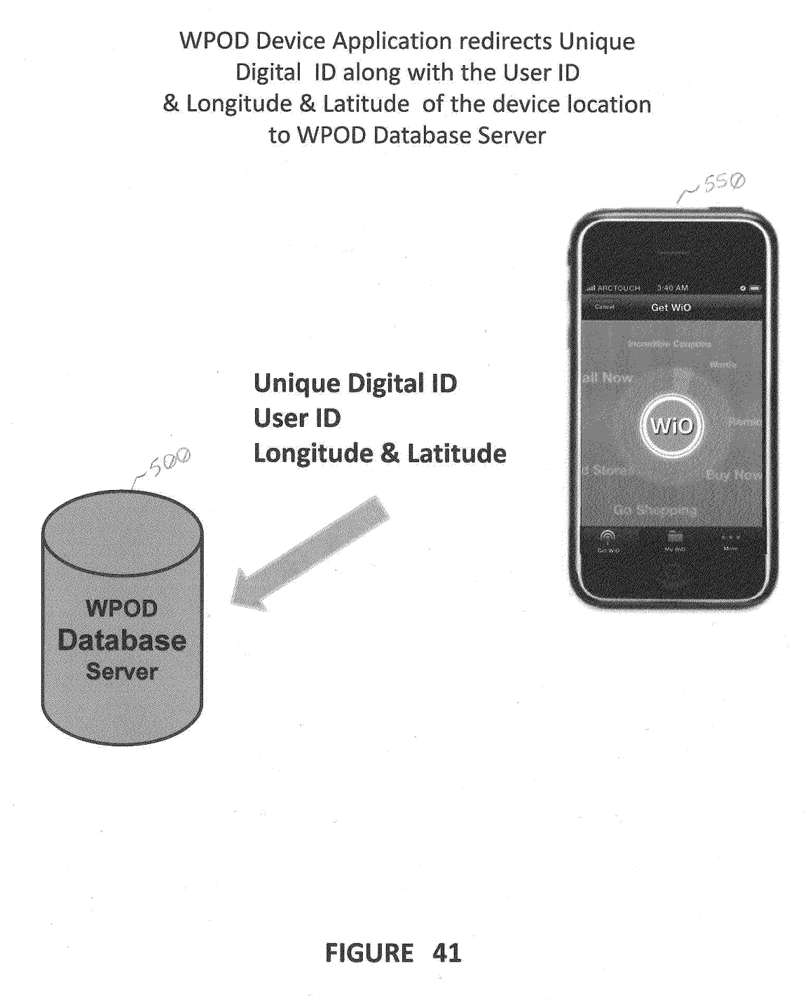

Referring now to FIG. 41, and correlating to step 175 of the WPOD wireless mobile application (consumer interface) the WPOD device application 550 redirects the digital ID along with the user ID, longitude and latitude of the device location registrants, User ID and date and time stamp to the WPOD database server 500.

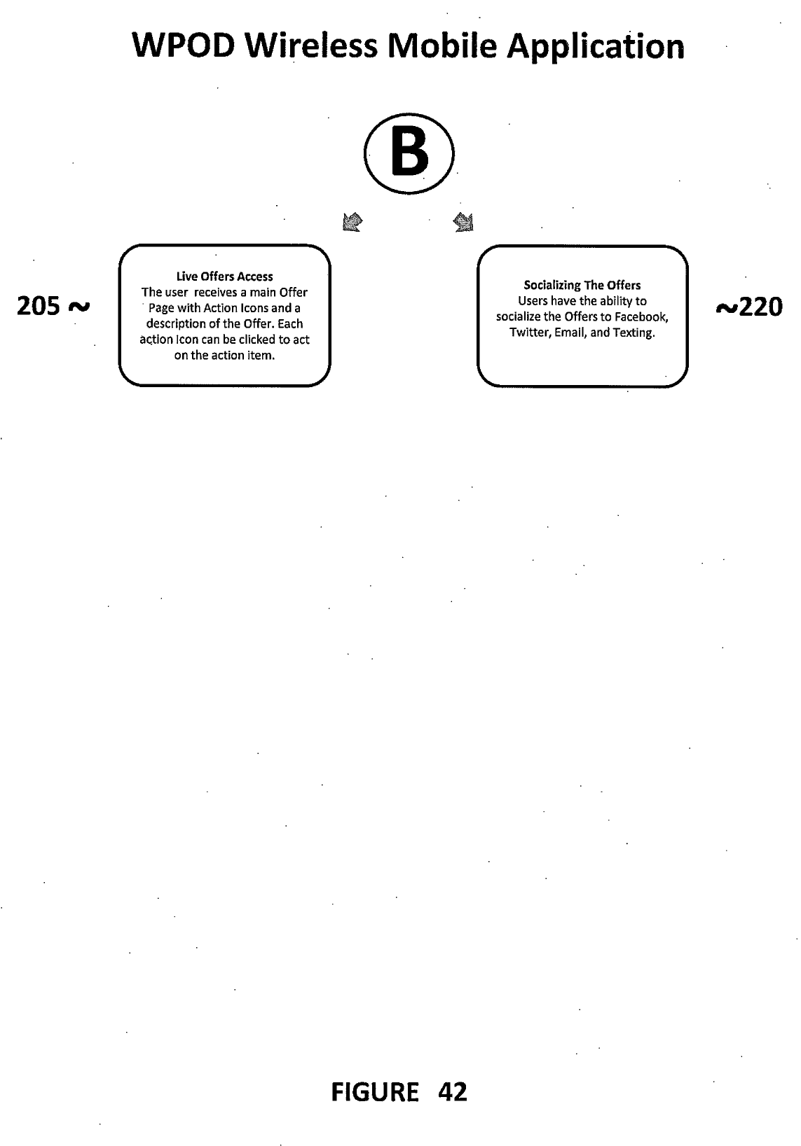

Referring specifically now to FIG. 42, after promotion, offer, information and product sale information is identified and delivered to the WPOD application on the wireless device, the registrant can choose to action on the delivered offers immediately by acting on the different actions associated with that offer in step 205 Alternatively, or in conjunction with, in step 220 the user may decide to “socialize” the promotion, offer and information by forwarding the promotion, offer, information and or product sales information to their friends and family or through their social network. In other words, the user will be able to forward the offer through Face book, Twitter, text message, or any other communication means by which the user may forward the promotion, offer, information and or product sales information.

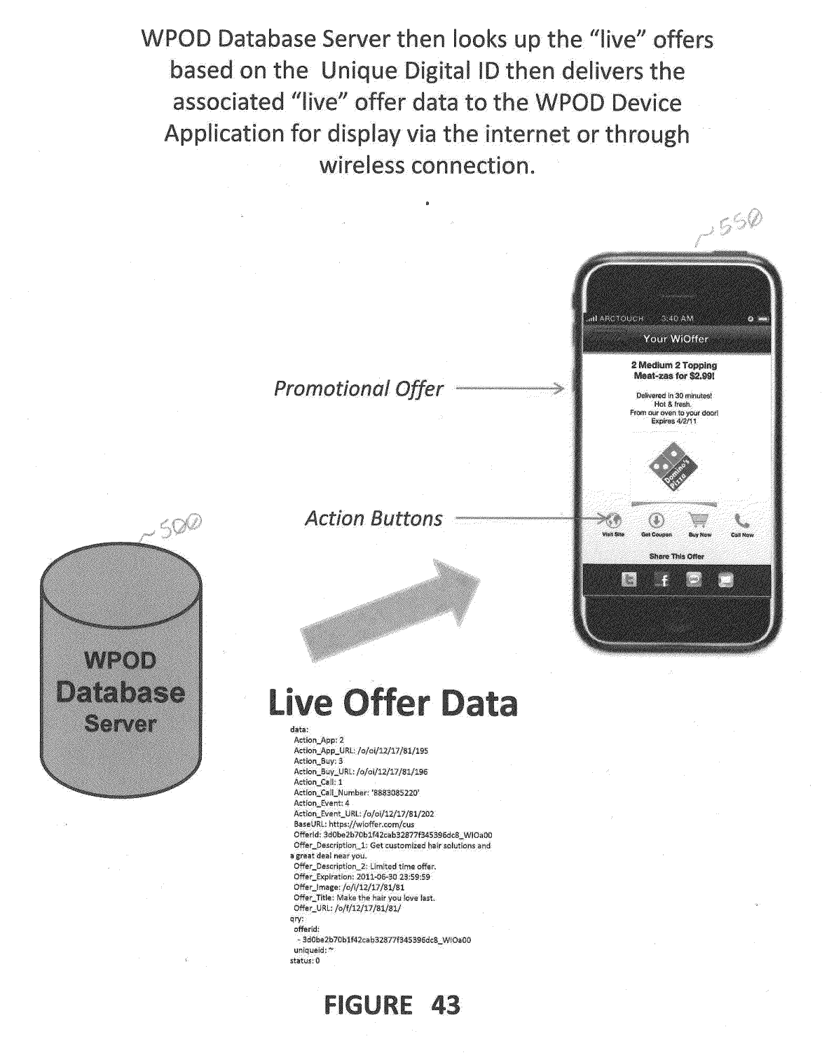

Referring now to FIG. 43, the transfer and delivery of live offers based on the unique digital ID from the WPOD database server 500 to the WPOD device application 550 is shown. Such transfer correlates to step 190 of the WPOD wireless mobile application (consumer interface), within the WPOD system components 8. As shown the live offer data, looked up by the WPOD database server 500 based on the unique digital ID, is delivered to the WPOD device 550 for display via the internet or through wireless connection. Included in the live offer data, is the title, product descriptions, product graphic, and action buttons associated with the offer actions. Also shown are the socialization buttons used to socialize that particular offer.

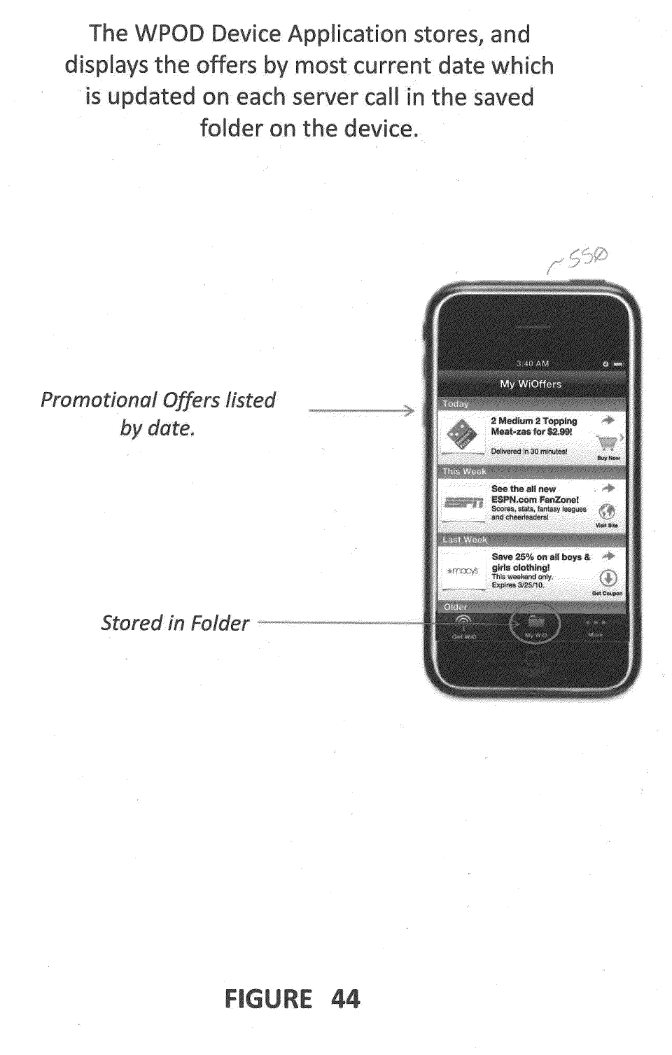

Referring now to FIG. 44, a portable handheld portable device 550 with WPOD live offers showing on the display is shown. This figure correlates to step 205 of the WPOD wireless mobile application. If the consumer registrant does not act upon the initial delivery of the of the offer within 30 seconds, the WPOD device application 550 stores and displays the offers by most current date in the MY WIO area of the WPOD application on the wireless device. Such is updated on each server call in the saved folder on the device.

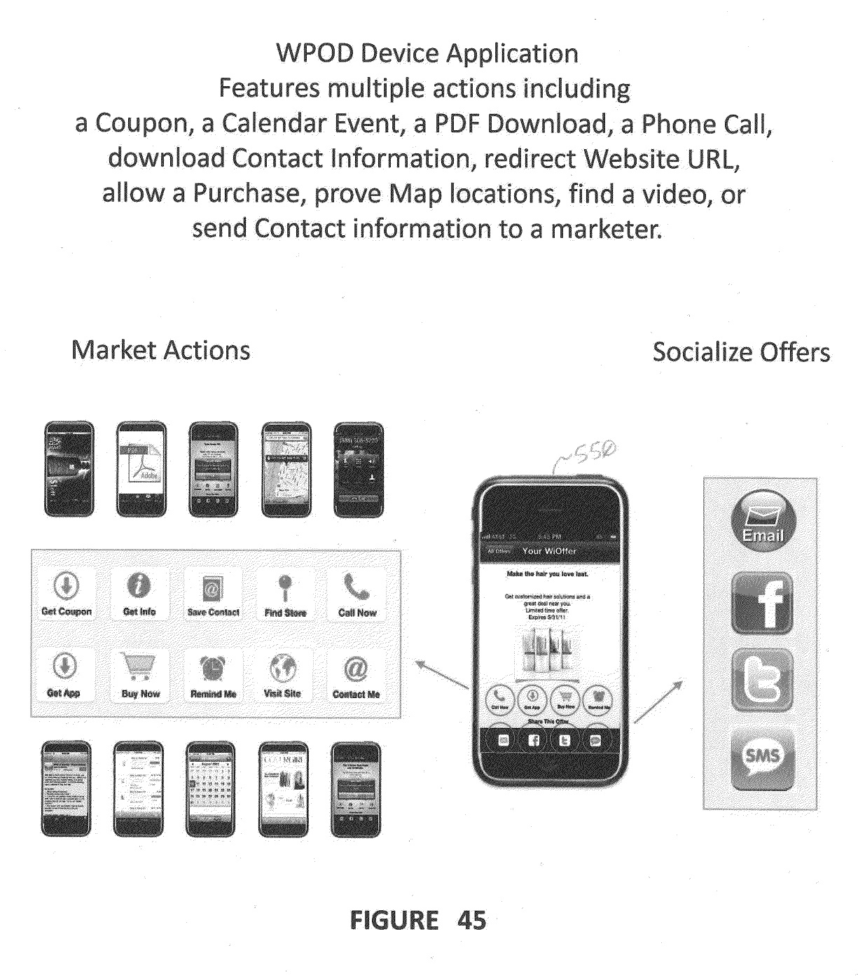

Referring now to FIG. 45, a WPOD device application 550 having various action applications is shown that an advertiser, content programmer or marketer can select from. Such features include a coupon, a calendar event, a PDF download, a phone call, download contact information, redirect website URL, allow a purchase, approve map locations, find a video, download an App, or send opt-in contact information to a marketer. These various action applications can be utilized through the portable handheld wireless device 550.

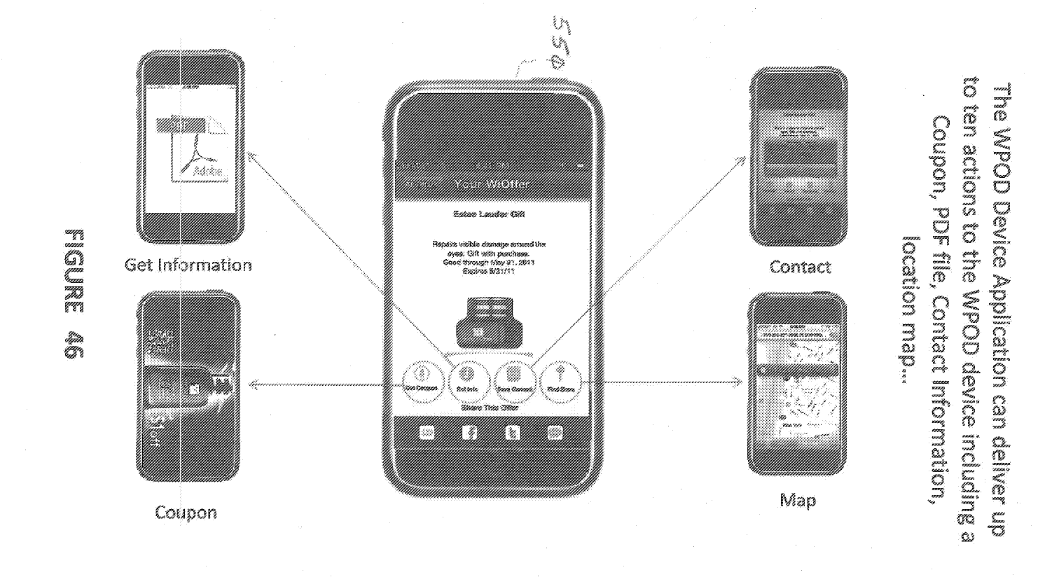

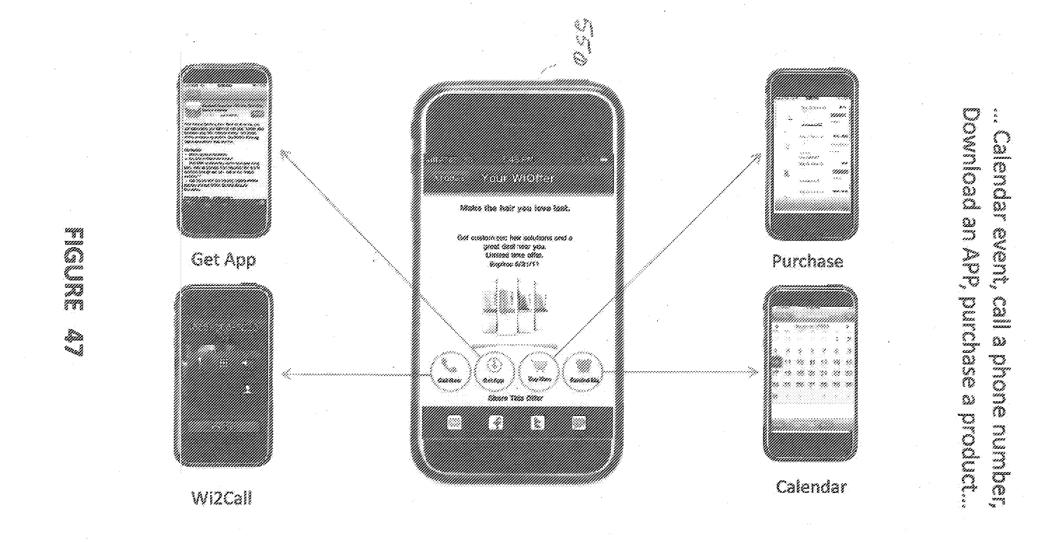

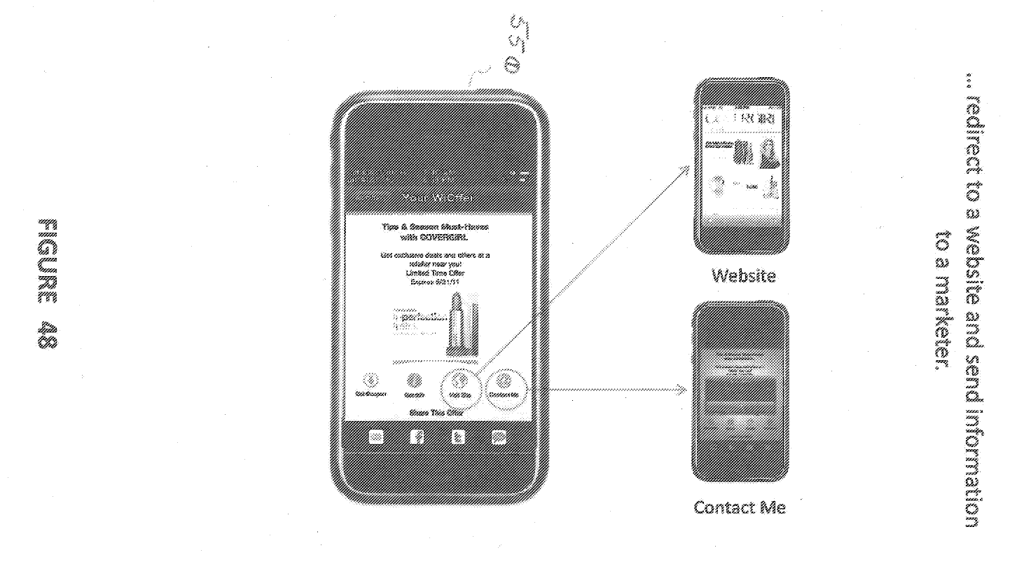

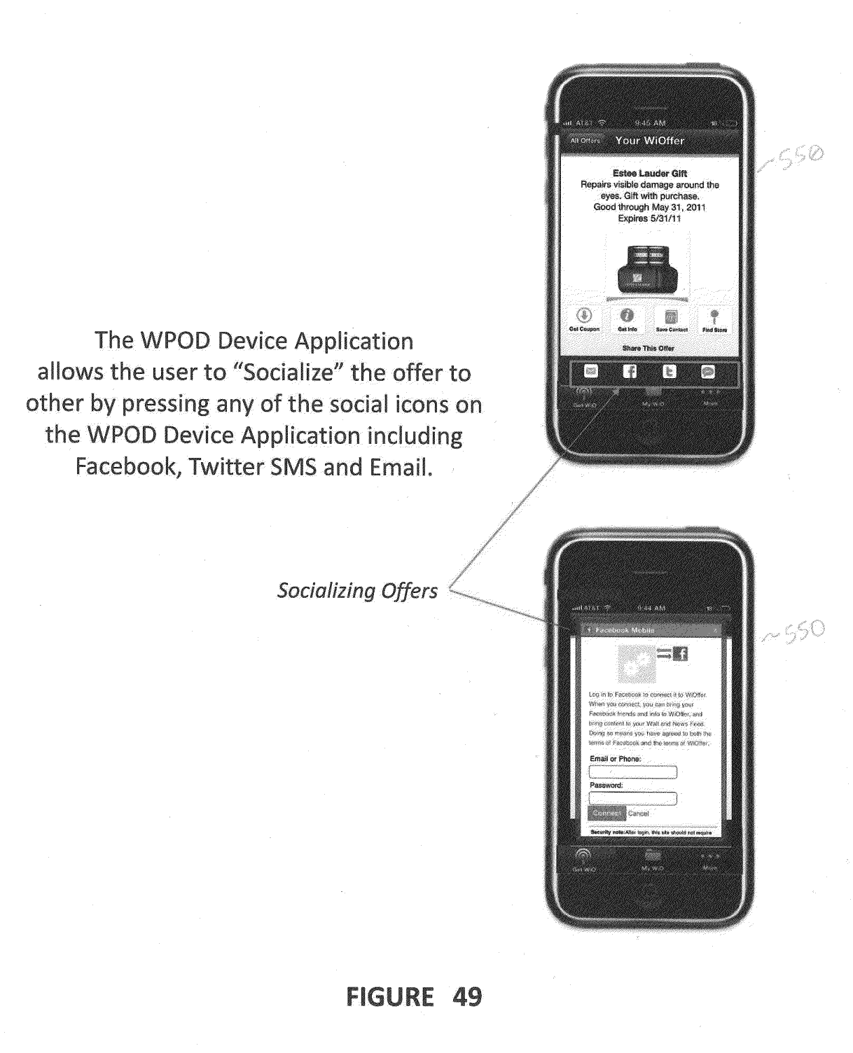

Referring now to FIGS. 46 through 49, the results of various action results are shown. Through selection on the portable handheld wireless device 550 various offer action icons are displayed, based on the action icon selected the appropriate offer is then displayed. For example in FIG. 46, related to a particular promotional offer “Estee Lauder Gift” a coupon can be obtained, information can be obtained, contact information can be obtained and the location of where to purchase the product may be obtained. FIGS. 47 and 48 likewise show various action icon selection abilities with various product actions being delivered. FIG. 49, relating to step 220 of the WPOD wireless mobile application, meanwhile allows the user to socialize the offer by pressing any of the social icons on the WPOD device application 550, including Facebook, Twitter, SMS Text and email.

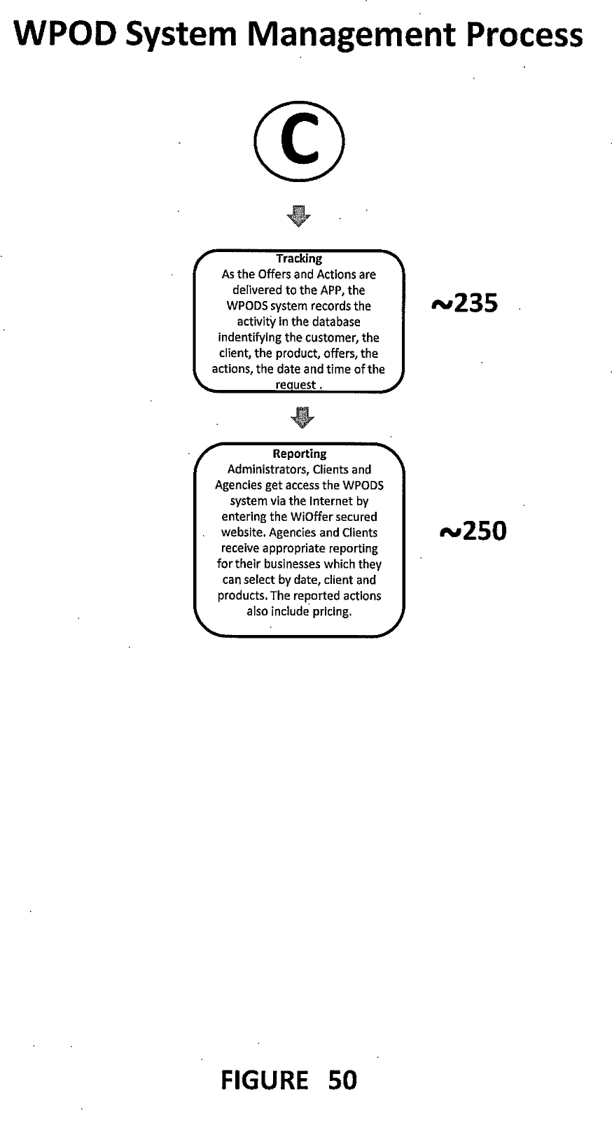

Referring now specifically to FIG. 50, the after delivery applications of the tracking and reporting component of the wireless promotional offer delivery system is shown. In step 235 the WPOD system tracks all of the delivered offers to the WPOD application on the wireless device. Such tracking includes client and product information, the date and time, geography, the number of offers delivered and their associated offer actions including promotions, offers, information and product sale information.

Having analyzed the data in step 235, the WPOD system in step 250 generates a report based on criteria selection.

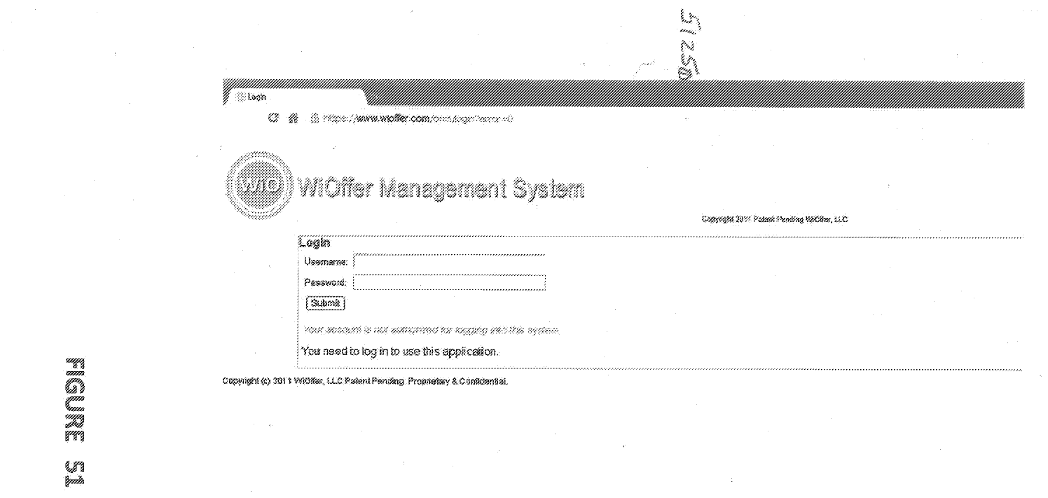

Referring now to FIG. 51, a screen shot 51250 shows an external login screen for the WPOD management system. This screen correlates to the WPOD system component 7 and steps 235 and 250 of the WPOD system management process. Herein an administrator and/or client may log in to track offers and actions and/or create reports.

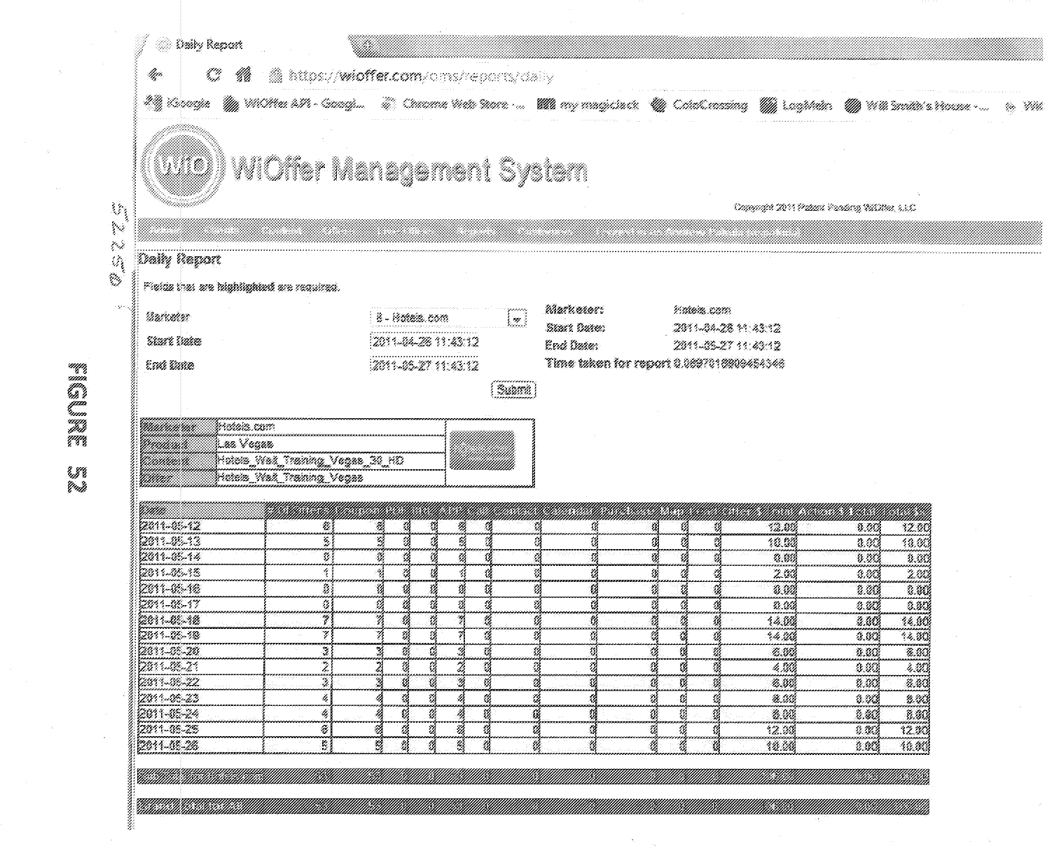

Referring now to FIG. 52, a screen shot of a daily report screen 52250 is shown.

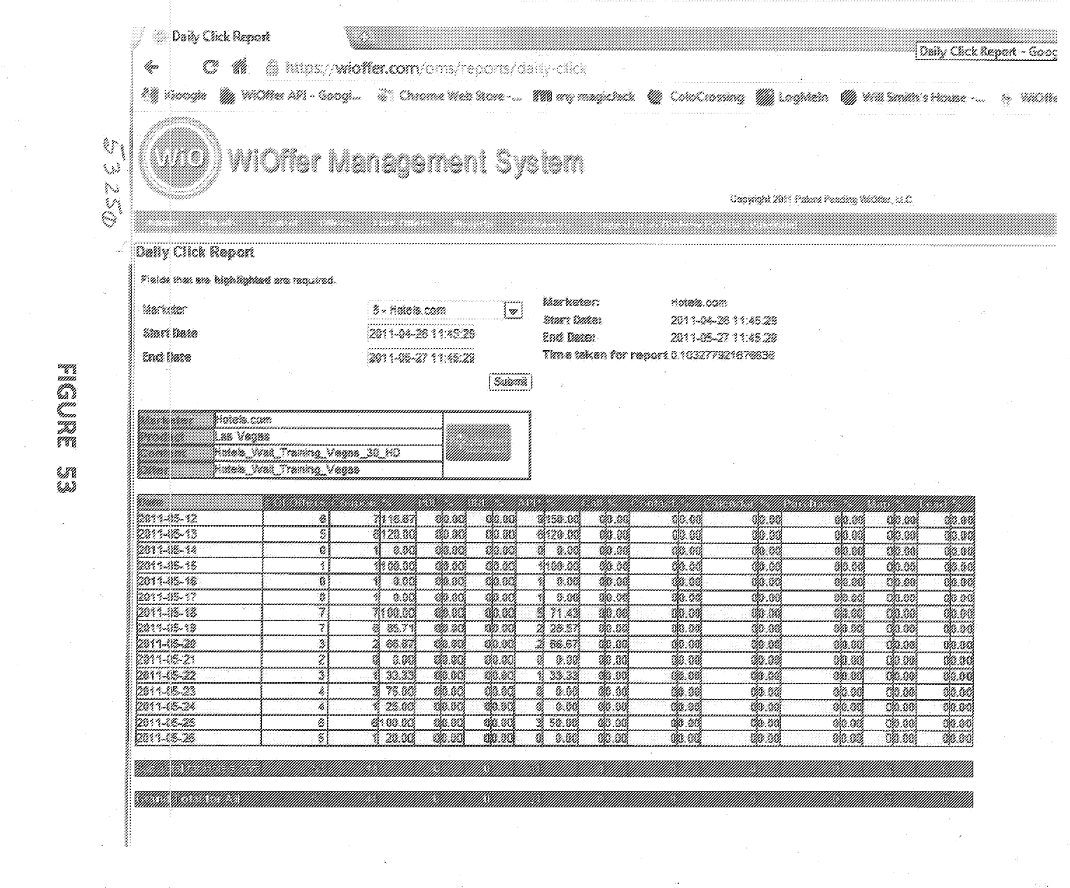

Referring now to FIG. 53, a daily click report screen 53250 is shown.

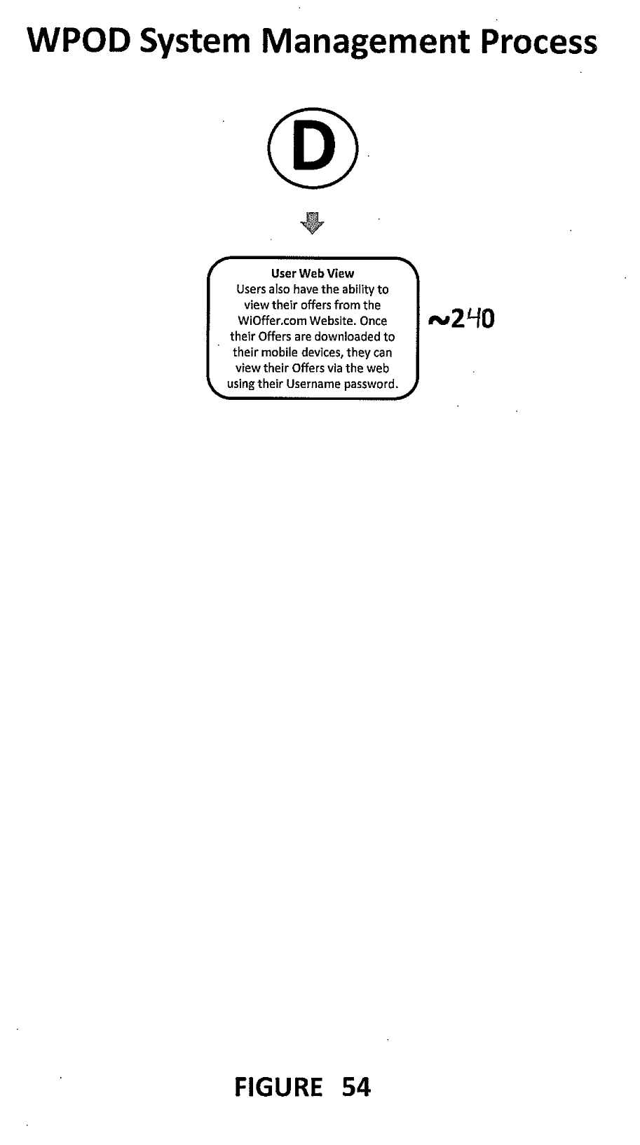

Referring now specifically to FIG. 54, the methodology by which the user accomplishes viewing of the promotional offers and downloads same is shown. In step 240 the user may view their saved offers by accessing the WPOD system website once such offers are downloaded from the mobile devices 550 to the WPOD database server 500. Such access is via the web utilizing their user name and password.

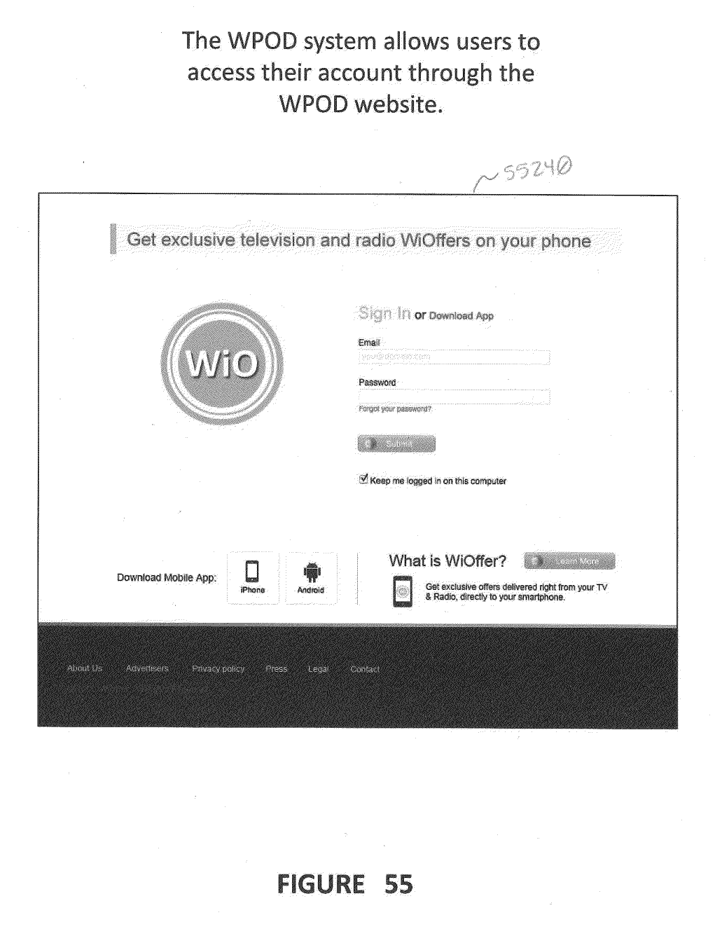

Referring now to FIG. 55, a screen shot 55240 is shown. In this screen shot 55240 the WPOD system allows the user to access their account through the WPOD website utilizing a user ID and password.

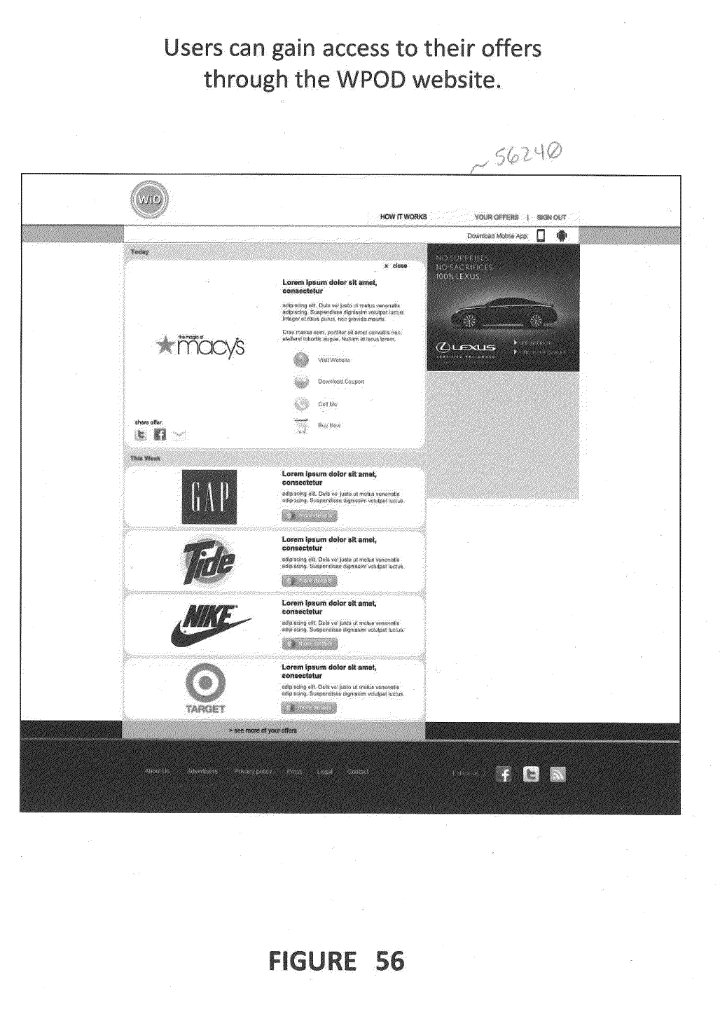

Referring now to FIG. 56, a screen shot 56240 showing various retailers to which the user may gain access through the WPOD website is shown. Here various exemplary advertiser offers are shown.

Additional Features: There are a couple of additional unique applications and/or features that are in the WPOD system:

Widgets Imbedded Technology—the WPOD application can include imbedding, the WPOD capability to work with a WPOD widget that can be imbedded in Smart TV's and Over The Top Box TV technology that delivers television programming and advertising. WPOD widget technology would include an application that wirelessly connects to the WPOD application on the mobile device through a network IP address. The user activates the WPOD application on the mobile device when they see a commercial or programming, the WPOD widget on the TV or Radio is activated to receive an audio sample or unique ID from within the TV or radio. The WPOD widget retrieved the audio sample then delivers the sample audio from the widget to the WPOD content server where it is identified and matched to an offer which is then delivered back to the WPOD Application on the mobile device.

WPOD Unique Code—WPOD application can include the ability to create a numerical code in an effort to deliver a wireless offer. By adding a unique alpha numerical WPOD code to the clients content upload area the WPOD can deliver the appropriate offer to the WPOD app wireless device. The viewer will see the code on a TV ad or print ad or hear it on a radio, and then enter the code in an area on the WPOD application on the mobile device. Once received, the offer can immediately be delivered.

Voice Recognition Ingestion—WPOD wireless application can include the ability to allow the viewer to speak into the WiO enabled device microphone speaking key brand names and phrases upon which the WPOD will recognize the keyword or phrases and search for the associated offer. Upon matching the associated offer with the keyword or phrases, the offer will then be delivered to the WPOD wireless app.

QR Code and Product Image Ingestion—WPOD application can include the ability to access QR Codes and Product images in an effort to deliver a wireless offer. By adding the QR Code and or image to the client's content upload area and adding a unique ID, the WPOD can deliver the appropriate offer based on that code.

Behavioral Targeting—Behavioral targeting that can be added in terms of the addressing offers based on the users own criteria for the type of offers they would like to receive from TV and Radio commercials. When provided, the WPOD Application on the wireless device will only receive those offers.

Self Serve WPOD System—This capability can allow advertisers, programmers and marketers to manage their own campaigns. They can register with WiOffer on the backend and be able to register their to load up their own video have it digitized with their own DNA and then they can put in their own offer and then they can run basically virtually without the assistance of WiOffer just being able to use their managing system, so that's a local self serve where they register, they pay, they do everything on their own without WiOffer actually assisting them.

Non-WiOffer Enabled Advertiser—This capability can allow a user when they hold up their mobile phone to a commercial and that commercial or that advertiser is not registered with WiOffer we are going to record that commercial and database that commercial and will be able then to go back to that advertiser and indicate how many people have asked for an offer from that advertiser based upon how many people tried to download an offer from a Non-WiOffer enabled Advertiser. This is an interesting piece of technology because it allows information to be gathered about people who are interested in a particular product but are not yet registered, so the system will be able to go back out and offer that.

Outbound Opted-In Messaging—This capability can allow for an individual registers with WiOffer they are going to leave their text information, their email information, the system will now have the database where it can text out to these individuals and be able to provide tune-in offers or other types of offers to work in a giant loop. So system will be able to re-contact these individuals through an out-going database.

In the foregoing description, the method and apparatus of the present invention have been described with reference to specific examples. It is to be understood and expected that variations in the principals of the method and apparatus herein disclosed may be made by one skilled in the art and it is intended that such modifications, changes, and substitutions are to be included within the scope of the present invention as set forth in the appended claims. The specification and drawings are accordingly to be regarded in an illustrative rather than a restrictive sense.

What is claimed is:

1. A method for wirelessly delivering promotional offers to a mobile device or a fixed computer station from television and radio advertising or program content, the method comprising the steps of:
uploading administration information and information on clients and their agencies on a WPOD database server to create administration passwords and passwords to access reports;
uploading contact information for a client, the clients product, their agencies and geographical locations of where to purchase the clients' products or receive services on the WPOD database server;
dynamically generating unique ID's for each client, each of their products and geographical location information on the WPOD database server;
associating the client and product information with the advertising and programming content on the WPOD database server;
uploading audio and video advertising or programming content on the WPOD database server;
analyze the uploaded audio and video advertising or programming content to dynamically create a unique digital ID based on the audio and video track of the advertising and programming content on the WPOD database server;
uploading the unique digital ID of the advertising or programming content to the WPOD database server;
dynamically generating a unique ID for the associated client/product information and advertising and programming content on the WPOD database server;
uploading a promotional offer including information about the offer along with selected marketing actions on the WPOD database server;
uploading PDF files, URL's, phone numbers, calendar information for each marketing action on the WPOD database server;
dynamically generating a unique ID for the promotional offer and each marketing action on the WPOD database server;
uploading a media schedule on the WPOD database server for the offer to coincide with advertising and programming TV schedules;
dynamically generating a unique ID for the media schedule for combining the offer and advertising or programming content;
associating the unique digital ID for the advertising and programming content with the unique ID for the promotional offer;
uploading pricing for the offer schedule on the WPOD database server;
dynamically generating a unique ID for the pricing;
capturing a audio or video timed segment on the mobile device;
sending the captured audio or video timed segment to the WPOD content server;
analyzing the captured audio or video segment;
matching the captured audio or video timed segment to the unique digital ID;
returning the unique digital ID to the WPOD application on the mobile device;
delivering the unique digital ID and the mobile devices current longitude and latitude coordinates, consumer ID and date/time stamp to the WiOffer server;
looking up the unique digital ID;
matching the “live” campaign offer with the digital ID;
delivering the most updated promotional offers and associated actions back to the mobile device or fixed computer station;
removal of the offer either manually or upon expiration of the offer on the mobile device; and
uploading to a companion website so that a registered user can see its offers at the WPOD website on a computer in addition to the mobile application.

2. The method according to claim 1, wherein the step of uploading client, product and geographical location information further comprises the steps of:
inputting information for the client, the agency and the administrator;
generating a unique ID for each of the client, the agency and the administrator inputted into a WPOD database;
inputting information for the client, the product and the geographical location; and
generating a unique ID for each of the client, the product and the geographic location;

3. The method according to claim 1, wherein the step of uploading the advertising or programming content on the WPOD database server further comprises the steps of:
naming the content;
assigning the content to the client and product;
uploading the content;
analyzing the audio and video tracks of the content;
creating a unique digital ID for the content; and
storing the content and the unique digital ID on the WPOD database server.

4. The method according to claim 1, wherein the step of uploading a promotional offer further comprises the step of:
inputting a description of the promotional offer; and
inputting a start date and an end date for the promotional offer;
associating geographical requirements of the offer;
selection of the actions associated with the offer; and
inputting the action items such as URL's, phone numbers, calendar events, and files.

5. The method according to claim 1, wherein the step of capturing an audio or video timed segment on the mobile device further comprises the steps of:
downloading the WPOD application to the mobile device or fixed computer;
registering a user information of the mobile device or the fixed computer;
listening to the content from the TV or other audio or video display; and
sending the capture audio segment to the content server for identification.

6. The method according to claim 5, wherein the step of registering a user information of the mobile device or the fixed computer further comprises the steps of:
sending the user information to the WPOD database server; and
approving the user to use the WPOD system.

7. The method according to claim 1, wherein the step of delivering the most updated promotional offers and associated actions back to the mobile device or fixed computer station further comprises the steps of:
recording the activity of the delivery of the promotional offer and associated actions in the WPOD server.

8. The method according to claim 7, wherein the step of recording the activity of the delivery of the promotional offer or associated actions in the WPOD server further comprises the step of:
identifying at least one of the user (customer), the client, the product, the promotional offer, the associated actions, the geographical location of the user, and the date and the time of the request.

9. The method according to claim 1, further comprising the steps of:
preparing reports of agency and client business on the WPOD system; and
sending the prepared reports to the agency and the client.

10. The method according to claim 1, further comprising the steps of:
the user receiving a promotional offer page with action icons,
wherein the user can click on the icon to act on the action item.

11. The method according to claim 1, wherein the user can socialize the promotional offers through at least one of Face Book, Twitter, E-mail and Texting.

12. An apparatus for wirelessly delivering promotional offers to a mobile device or a fixed computer station from television and radio advertising or program content, the apparatus comprising:
a WPOD server database, which allows for creation of a unique digital ID to be associated with the content;
at least one data entry port through which promotions, offers, information and products sales may be added to the server database and associated with the digital ID;
a handheld wireless mobile device capable of having a WPOD application downloaded into its memory; and
a television, radio or other device for airing of the content,
wherein a sample of the content is recorded and captured by the mobile device and then delivered to the WPOD server where it is analyzed and matched, and
wherein once the sample has been identified and matched, the promotions, offers, information and product sales are delivered to the WPOD application on the wireless device.

13. The apparatus according to claim 12, the apparatus further comprising:
a computer system where the promotions, offers, information and or product sales are available via a password protected website for consumer access where the information may be viewed or printed out.
